(19) United States
(12) Patent Application Publication
(10) Pub. No.: US 2025/0375756 A1
(43) Pub. Date: Dec. 11, 2025

(54) MICROPOROUS POLYMER NETWORKS FOR CARBON DIOXIDE CAPTURE

(71) Applicant: TOYOTA MOTOR ENGINEERING & MANUFACTURING NORTH AMERICA, INC., Plano, TX (US)

(72) Inventors: John MULDOON, Saline, MI (US); Mikhail Y. REDKO, Ann Arbor, MI (US); John B. WAUGH, Ann Arbor, MI (US); Hassina TABASSUM, Ann Arbor, MI (US); Charles A. ROBERTS, Farmington Hills, MI (US); Michael JONES, Orchard Lake, MI (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 18/738,577

(22) Filed: Jun. 10, 2024

(51) Int. Cl. B01J 20/26; B01D 53/62; B01D 53/81; B01D 53/96; B01J 20/30; C08G 73/06

(52) U.S. Cl. CPC B01J 20/264; B01D 53/62; B01D 53/81; B01D 53/96; B01J 20/3071; B01J 20/3085; C08G 73/0644; C08G 73/065; B01D 2253/202; B01D 2257/504; B01D 2258/01; B01D 2258/0283; B01D 2258/06; B01D 2259/4009

(57) ABSTRACT

A microporous organic triazine polymer network of repeating triazine units copolymerized with hydrocarbon aromatic monomer units and/or heterocyclic aromatic monomer units arranged in a three dimensional porous network containing polyamine groups covalently bonded through an amino linkage to at least a portion of the aromatic monomer units is provided. Method to prepare the microporous organic triazine polymer network are also provided. A method for removal of carbon dioxide from a gaseous mixture employing the microporous organic triazine polymer network is also provided.

### BACKGROUND OF THE INVENTION

### Field of the Invention

This disclosure is directed to novel microporous polymer networks capable to adsorb CO₂ which are stable in humid environments and are stable to oxidation.

### Description of the Related Art

Impending problems associated with climate change necessitate the need for innovation and development of new and effective methods to reduce, and reverse, the negative effects of climate change. Carbon dioxide has been identified as the main antagonist of climate change, therefore efforts to curb climate change typically focus on reducing CO₂ from emissions or removing CO₂ from the environment. Removing CO₂ from the environment through the process of CO₂ capture has gained significant attention as a method of environmental remediation. Capturing CO₂ from more concentrated sources, such as flue gas from an industrial plant, is important. However, the holy grail of CO₂ capture is direct air capture (DAC), which is removal of CO₂ from air with “natural” concentrations of CO₂ (400 ppm CO₂), without prior purification or treatment. Technological innovations have focused on absorbents, or materials that can adsorb CO₂ from gas streams, for CO₂ DAC. These materials can adsorb CO₂ through physisorption, by leveraging high porosity and high surface area materials, or through chemisorption, by chemically binding CO₂. Chemisorption may be accomplished employing amines, which react with CO₂ to form a carbamate that can be subsequently controllably released.

One type of absorbent that has attracted significant attention for CO₂ capture is constructed of metal-organic frameworks (MOFs). Metal-organic frameworks are organic-inorganic hybrid crystalline materials comprising inorganic metal clusters and organic linkers. MOFs can be tuned according to the metal centers employed, types of organic linkers, and other properties such as porosity, surface area, and functionalization. For these reasons MOF has attracted attention as an absorbent for CO₂ capture. The MOFs used in CO₂ capture can be used to physisorb CO₂ by increasing their surface area and porosity. MOFs can also be used to chemisorb CO by functionalization or attachment with amines [W. R. Lee, C. S. Hong, Chem. Sci. 2015, 6, 3697], [T. M. McDonald, J. R. Long, Nature, 2015, 519, 303-308]. Amines react with CO₂ to generate ammonium carbonates, bicarbonates and carbamates, thus effectively removing the CO₂ from the gas stream. The chemisorbed CO₂ can be released from the chemisorbed state by treatment with heat. However, MOFs have significant problems which limit their usability in practical CO₂ capture systems. The primary issue with MOFs structures is water instability. Under humidified conditions MOFs can undergo hydrolysis, leading to degradation of the absorbent and reduced CO₂ capture performance. In a practical system, such as direct air capture (DAC), the gas feed will naturally be humidified. Direct air capture is the primary goal of CO₂ capture technologies; therefore, MOFs face significant fundamental challenges which inhibit their applicability as DAC absorbents.

Another class of materials used as CO₂ capture adsorbents are covalent organic frameworks (COFs). COFs are crystalline, porous materials that are assembled via strong directional covalent bonds between linkers and organic cores. COFs are promising for CO₂ capture due to their inherent porosity, ability to be functionalized, and chemical/thermal stability [K. Geng. D. Jiang, Chem. Rev. 2020, 120, 8814-8933], [H. Li. D. Zhao, Chem. Soc. Rev. 2023, 52, 6294-6329]. Importantly, COFs are stable in water, which makes them more suitable than MOFs for practical CO₂ capture applications where water is present. COFs may be designed to effectively physisorb CO₂ by increasing surface area and porosity or to chemisorb CO₂ by functionalization with amines. Yaghi et al. were the first to incorporate an amine into a COF structure and use it to capture CO₂ [H. Lyu. O. M. Yaghi, J. Am. Chem. Soc. 2022, 144, 12989-12995]. Numerous post-synthesis steps to preparation of the COF were necessary to result in an aminated COF. In further work, Yaghi et al. functionalized the COF precursors with fluorine before assembly into the framework [X. Han. O. M. Yaghi, J. Am. Chem. Soc. 2023, 146, 89-94]. These fluorine functional groups were then substituted for sulfur groups that had amines attached to them in a protected form. Later the protection groups were removed to produce amines. One concern of these reported materials is the reproducibility of the final material claimed in the articles.

One concern associated with these materials is oxidative stability, which may dramatically hinder CO₂ release and the CO₂ capacity of the material after thermal cycling. While CO₂ adsorption by the materials was demonstrated, the subsequent thermal release of CO₂ was not demonstrated. This is presumably due to the limited oxidative stability of the material. This inhibits the efficacy of this class of COF materials for direct air capture of CO₂, where oxidative stability is of significant concern. The materials described herein offer enhanced oxidative stability under direct air capture conditions, thus making them more effective for DAC applications.

Thus, there remains a need to develop materials having high capacity for CO₂ capture which are stable to hydrolysis and thermal oxidation and capable to be recycled through CO₂ capture and controlled release cycles repeatedly.

Accordingly, an object of the present disclosure is to provide a material having a microporous structure containing chemical functionalities capable of reversible physisorption and reversible chemisorption of CO₂ wherein the material is stable to hydrolysis in a humid environment and is stable to oxidation at temperatures employed to controllably release CO₂.

Another object of the present disclosure is to provide methods which are efficient and capable to be run at an industrial scale to prepare materials having a microporous structure containing chemical functionalities capable of reversible physisorption and reversible chemisorption of CO₂ which are stable to hydrolysis in a humid environment and stable to oxidation at temperatures employed to controllably release CO₂.

A further object is to provide a method and device for the cyclic removal and controlled release of CO₂ from a gaseous environment.

### SUMMARY OF THE INVENTION

These and other objects are provided by the embodiments of the present disclosure, the first embodiment of which includes a microporous organic triazine polymer network, comprising: repeating triazine units copolymerized with hydrocarbon aromatic monomer units and/or heterocyclic aromatic monomer units arranged in a three dimensional porous network; and polyamine groups covalently bonded through an amino linkage to at least a portion of the aromatic monomer units.

In one aspect of the first embodiment, the aromatic monomer units consist of heterocyclic aromatic monomer units derived from heterocyclic compounds substituted with two or more carbonitrile groups and in a further aspect, at least a portion of the heterocyclic aromatic monomer units are derived from heterocyclic compounds substituted with three or more carbonitrile groups.

In one aspect of the first embodiment, the aromatic monomer units consist of units derived from hydrocarbon aromatic compounds substituted with two or more carbonitrile groups, and in a further aspect, at least a portion of the hydrocarbon aromatic monomer units are derived from hydrocarbon aromatic compounds substituted with three or more carbonitrile groups.

In one aspect of the first embodiment, the aromatic monomer units consist of hydrocarbon aromatic units and heterocyclic aromatic monomer units.

In one aspect of the first embodiment, a content of the polyamine groups covalently bonded through amino linkage to at least a portion of the aromatic monomer units is from 1.0 mass % to 50 mass % of the total mass of the microporous organic triazine polymer network.

In a further aspect of the first embodiment, the aromatic monomer units comprise a heterocyclic aromatic monomer and the organic polymer network further comprises a metal or metal ion coordinated and/or bonded with heteroatoms of the organic polymer network. The metal or metal ion is selected from the group consisting of monovalent, bivalent, and trivalent metals. A content of the metal or metal ion is from 0.1 mass % to 10 mass % of the total mass of the microporous organic triazine polymer network.

In a second embodiment, the present disclosure provides a method to prepare a microporous organic triazine polymer network having covalently bonded polyamine groups, comprising: preparing an intimate mixture comprising a hydrocarbon aromatic compound having three or more carbonitrile groups and/or a heterocyclic aromatic compound having three or more carbonitrile groups and an acid catalyst;
placing the intimate mixture in a dry, oxygen-free polymerization device;
polymerizing the hydrocarbon aromatic compound having three or more carbonitrile groups and/or the heterocyclic aromatic compound having three or more carbonitrile groups in the dry, oxygen-free polymerization device by heating the intimate mixture to a temperature of from 200-500° C.;
isolating the microporous organic triazine polymer;
reacting the microporous organic triazine polymer with a polyamine to covalently graft the polyamine to the triazine polymer network; and
isolating the microporous organic triazine polymer network having covalently bonded polyamine groups.

In one aspect of the second embodiment, the microporous organic triazine polymer comprises a labile halogen bonded to the organic triazine polymer, and covalently grafting the polyamine to the triazine polymer is conducted by nucleophilic aromatic substitution displacement of the halogen with the polyamine.

In one aspect of the second embodiment, the microporous organic triazine polymer comprises a halogen bonded to a hydrocarbon aromatic ring of the organic triazine polymer, and covalently grafting the polyamine to the triazine polymer is conducted by displacement of the halogen with the polyamine in the presence of an alkoxide base, ligand, and a palladium salt.

In one aspect of the second embodiment, the microporous organic triazine polymer does not comprises a halogen bonded to the organic triazine polymer, and covalently grafting the polyamine to the organic triazine polymer is conducted by oxidative nucleophilic substitution of an aromatic hydrogen in the presence of an oxidant and a catalyst.

In one aspect of the second embodiment, the microporous organic triazine polymer comprises a quinone structure, and covalently grafting the polyamine to the organic triazine polymer is conducted by nucleophilic addition of the polyamine to the quinone group.

In another aspect of the second embodiment, the intimate mixture comprises a heterocyclic aromatic compound having three or more carbonitrile groups, and the method further comprises treating the isolated microporous organic triazine polymer network having covalently bonded polyamine groups with a solution of a metal or a metal salt to coordinate the metal or metal ion of the salt with heteroatoms of the organic triazine polymer.

In a third embodiment, the present disclosure provides a method for removal of carbon dioxide from a gaseous mixture, comprising: preparing an adsorbent bed containing the microporous organic triazine polymer network of the first embodiment in all aspects which is essentially free of CO₂;
exposing a gaseous mixture containing carbon dioxide to the adsorbent bed to i) physisorb the CO₂ into a microporous structure of the microporous organic triazine polymer network, ii) chemisorb the CO₂ by reaction with amine groups of the polyamine groups within the microporous structure of the microporous organic triazine polymer network; or iii) physisorb and chemisorb the CO₂ into a microporous structure of the microporous organic triazine polymer network according to i) and ii).

In an aspect of the third embodiment, the gaseous mixture is atmospheric air, an off gas from a combustion process or an exhaust gas of fuel propelled vehicle.

In an aspect of the third embodiment, the method further includes heating the adsorbent bed to a temperature of from 30° C. to 200° C., optionally under flow of an inert gas to expel the physisorbed and chemisorbed CO₂ and return the microporous organic triazine polymer network to being essentially free of adsorbed CO₂; and in a further variation of this aspect the exposing a gaseous mixture containing carbon dioxide to the adsorbent bed and heating the adsorbent bed having physisorbed and chemisorbed CO₂ to expel the physisorbed and chemisorbed CO₂ and return the microporous organic triazine polymer network to being essentially free of adsorbed CO₂ is cyclically repeated.

In a fourth embodiment, the present disclosure provides a device for removal of carbon dioxide from a gaseous mixture, comprising an adsorbent bed containing the microporous organic triazine polymer network of the first embodiments in all aspects disclosed.

The forgoing description is intended to provide a general introduction and summary of the present invention and is not intended to be limiting in its disclosure unless otherwise explicitly stated. The presently preferred embodiments, together with further advantages, will be best understood by reference to the following detailed description taken in conjunction with the accompanying drawings.

Additional advantages and other features of the present invention will be set forth in part in the description that follows and in part will become apparent to those having ordinary skill in the art upon examination of the following or may be learned from the practice of the present invention. The advantages of the present invention may be realized and obtained as particularly pointed out in the appended claims. As will be realized, the present invention is capable of other and different embodiments, and its several details are capable of modifications in various obvious respects, all without departing from the present invention. In this regard, the description herein is to be understood as illustrative in nature, and not as restrictive.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows an example of an ionothermal synthesis of a microporous organic triazine polymer network according to an embodiment of the disclosure.

FIG. 2 shows the FTIR spectra of the starting material and product for the example of FIG. 1.

FIG. 3 shows the XPS NIs spectra of the product for the example of FIG. 1.

FIG. 4 shows the XRD spectra of the product for the example of FIG. 1.

FIG. 5A shows the adsorption/desorption isotherms of the product for the product of FIG. 1.

FIG. 5B shows the pore size distribution obtained by NLDFT analysis for the product of FIG. 1.

FIG. 6 shows an example of a synthesis of a microporous organic triazine polymer network according to an embodiment of the disclosure.

FIG. 7 shows the FTIR spectra of the starting material (X=Cl) and product for the example of FIG. 6.

FIG. 8A shows the XPS Nis spectra for the product of the example of FIG. 6.

FIG. 8B shows the XPS Cl 2p spectra for the product of the example of FIG. 6.

FIG. 9A shows a scanning electron microscope (SEM) image of the synthesized halogen-containing COF material of FIG. 6.

FIG. 9B shows a SEM Energy dispersive X-ray spectroscopy (EDX) image of the synthesized halogen-containing COF material of FIG. 6.

FIG. 9C shows a chlorine elemental map obtained from SEM-EDX of the synthesized halogen-containing COF material of FIG. 6.

FIG. 10 shows an example of the synthesis of a microporous organic triazine polymer network according to an embodiment of the disclosure.

FIG. 11 shows an example of the application of a Buchwald-Hartwig amination of a non-activated aryl halide according to an aspect of the disclosure.

FIG. 12 shows examples of ligands used in the Buchwald-Hartwig amination of a non-activated aryl halide according to an aspect of the disclosure.

FIG. 13 shows an example of a nucleophilic aromatic substitution amination according to an aspect of the disclosure.

FIG. 14 shows an example of a nucleophilic aromatic substitution amination according to an aspect of the disclosure.

FIG. 15 shows an example of an oxidative nucleophilic hydrogen substitution amination according to an aspect of the disclosure.

FIG. 16 shows the infrared spectra of the components and reaction product of FIG. 15.

FIG. 17 shows the FTIR spectra of the components and reaction product of FIG. 15.

FIG. 18A shows CO₂ capture from a flue gas feed showing temperature, CO₂ flow rate and CO₂ adsorption over time obtained with one example of the disclosure.

FIG. 18B shows CO₂ adsorption vs CO₂ concentration in a flue gas and over time obtained with one example of the disclosure.

FIG. 19A shows CO₂ capture from a flue gas feed showing temperature, CO₂ flow rate and CO₂ adsorption over time obtained with one example of the disclosure.

FIG. 19B shows CO₂ adsorption vs CO₂ concentration in a flue gas and over time obtained with one example of the disclosure.

FIG. 20A shows a scheme for carbamate formation reaction upon interactions of aminated COF with CO₂.

FIG. 20B shows the infrared transmission spectra of the aminated COF (COF+en) material dried at elevated temperature (thin dotted line, COF+en dried), exposed to the air (thick dotted line. COF+en air exposed), and exposed to moisture and CO₂ (solid line, COF+en wet CO₂ exposed).

FIG. 20C shows spectra in the 1612-1688 cm⁻¹ region, corresponding to the carbamate absorption of the aminated COF (COF+en) material dried at elevated temperature (thin dotted line, COF+en dried), exposed to the air (thick dotted line. COF+en air exposed), and exposed to moisture and CO₂ (solid line, COF+en wet CO₂ exposed). The 1648 cm⁻¹ frequency, corresponding to the carbamate absorption intensity maximum, is marked with a vertical dashed line.

### DETAILED DESCRIPTION OF THE PREFERRED EMBODIMENTS

In the description that follows, the words “a” and “an” and the like carry the meaning of “one or more.” The phrases “selected from the group consisting of,” “chosen from,” and the like include mixtures of the specified materials. Terms such as “contain(s)” and the like are open terms meaning ‘including at least’ unless otherwise specifically noted.

All references, patents, applications, tests, standards, documents, publications, brochures, texts, articles, etc. mentioned herein are incorporated herein by reference. Where a numerical limit or range is stated, the endpoints are included. Also, all values and subranges within a numerical limit or range are specifically included as if explicitly written out. Technical terms used in the description, if not explicitly defined herein, carry the definition recognized by one of ordinary skill in the art.

In view of the need for enhanced CO₂ capture materials having hydrolytic and thermal oxidative stability, the present inventors have investigated organic systems having a porous three dimensional framework. While covalent organic framework materials (COFs) are a promising class of materials for CO₂ capture because of good hydrolytic stability, materials reported to date have low oxidative stability. A material with low oxidative stability will experience CO₂ capacity fade during cycling, limiting its efficacy in long-term CO₂ capture applications. The search was directed to identification and preparation of COFs having high oxidative stability, such that the CO₂ adsorption capacity of the material remains high after thermal release of CO₂. A material having such combination of properties would provide for high performance, long durability CO₂ capture.

In this study COFs based upon triazine units linked by aromatic monomer units derived from aromatic compounds having two or more carbonitrile groups and having polyamine side chains bonded directly to the aromatic unit through an amine bond (N—C) were prepared and investigated for CO₂ capture and release performance.

Covalent organic frameworks (COFs) were synthesized by acid-catalyzed polymerization of dinitriles (dicarbonitriles), trinitriles (tricarbonitriles) and other compounds converting into triazines upon synthesis conditions. Protie acids (Brønsted acids), as well as non-protic electron acceptors (Lewis acids), such as metal salts, complex acids, their metal salts, and combinations of the compounds listed above, can be used as catalysts. Non-reactive liquid dilutants can be used to dissolve the reactants.

The protic acids used in this synthetic approach include, but are not limited to, HF, HCl, HBr, HI, sulfuric acid, disulfuric acid, polysulfuric acid, halosulfonic acids (HSO₃F, HSO₃Cl). Other catalysts include acids such as sulfonic acids of a general formula RSO₃H where R can be, but not limited to, alkyl, aryl, halogenated alkyl or halogenated aryl substituents can be used. Said acids can be methanesulfonic acid (CH₃SO₃H), ethanesulfonic acid, benzenesulfonic acid, toluenesulfonic acid, trifluoromethylsulfonic acid, perfluoroethanesulfonic acid can be used in this synthetic approach. Inorganic phosphorous-based acids can be used, including polyphosphoric acids of a general formula H₂PO₄*nP₂O₅, which include but are not limited to, tetraphosphoric acid (H₆P₄O₁₃) and fluorophosphoric acid such as H₂PO₃F and HPO₂F₂. Imino-based Bronsted acids of a general formula HNR₁R₂, where R₁ and R₂ are electron-withdrawing groups can be used, including but not limited to fluorosulfonyl, alkylsulfonyl, arylsulfonyl, and their substituted derivatives such as methylsulfonyl, ethylsulfonyl, phenylsulfonyl, trifluoromethylsulfonyl. Examples of corresponding acids include HN(SO₂F)₂ and HN(SO₂CF₃)₂.

The COFs can be synthesized using Lewis acids, such as solid metal salts, as catalysts in an ionothermal polymerization reaction. In this case, the COFs were synthesized in an ionothermal reaction by heating mixtures of the Lewis acids with organic materials to temperatures sufficient to bring all of the mixture components into a melt, typically from the ambient up to 600° C.

The Lewis acids that were used as catalysts include, but are not limited to, compounds formed by such elements as B, Al, Ga, In, Se, Y, La, all of the lanthanides, Si, Ge, Sn, Ti, Zr, Hf, P, As, Sb, Bi, V, Nb, Ta, Mn, Fe, Co, Ni, Cu, Ag, Au, Zn, Cd, Hg, Th, U with the abovementioned acids. Examples of the Lewis acid catalysts are BF₃, ZnCl₂, ZnBr₂, Zn(CF₃SO₃)₂, Zn[N(SO₂CF₃)₂], Cd(CF₃SO₂)₂, Cd[N(SO₂CF₃)₂]₂, La(C₄F₉SO₃)₃.

Complex Brønsted acids can be used as catalysts for the synthesis of COFs. Those include compounds formed by the reaction of protic acids and electron-deficient compounds. Any acid mentioned previously can be used as a component of a complex acid, and the metal or semimetal compounds containing the anions of those Brønsted acids can be used as electron-deficient components.

Examples of the complex acids include, but are not limited to, HBF₄, HPF₆, HSbF₆; HNbF₆, HB(HSO₄)₄, HAlCl₄. HAl₂Cl₇. The metal salts of the complex acids include, but are not limited to, Zn(AlCH₄)₂, La(AlCl₄)₃, and Cd(BF₄)₂. The combinations of the compounds listed above include but are not limited to, superacids HSbFₙ(SO₃F)₆₋ₙ, where 0<n<7.

The non-reactive liquid dilutants include, but are not limited to, alkanes, halogenated alkanes, and aromatic compounds containing deactivating (electron-withdrawing) substituents, such as nitro group or halogens. Examples of such dilutants include, but are not limited to, dichloromethane, chloroform, nitrobenzene, chlorobenzenes, and hexafluorobenzene. Other examples of dilutants include, but are not limited to, carbon disulfide, phosphorus oxychloride, and liquid sulfur dioxide.

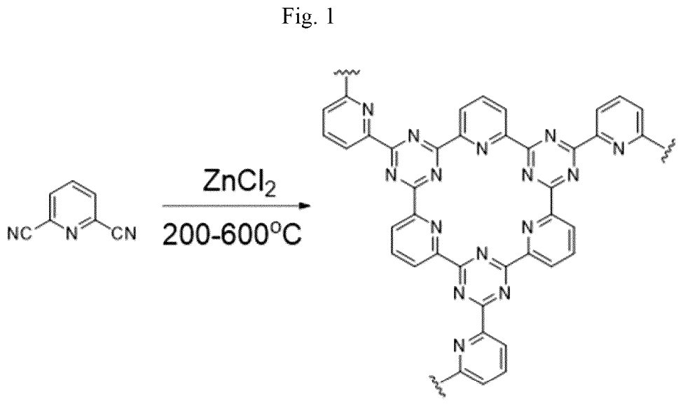

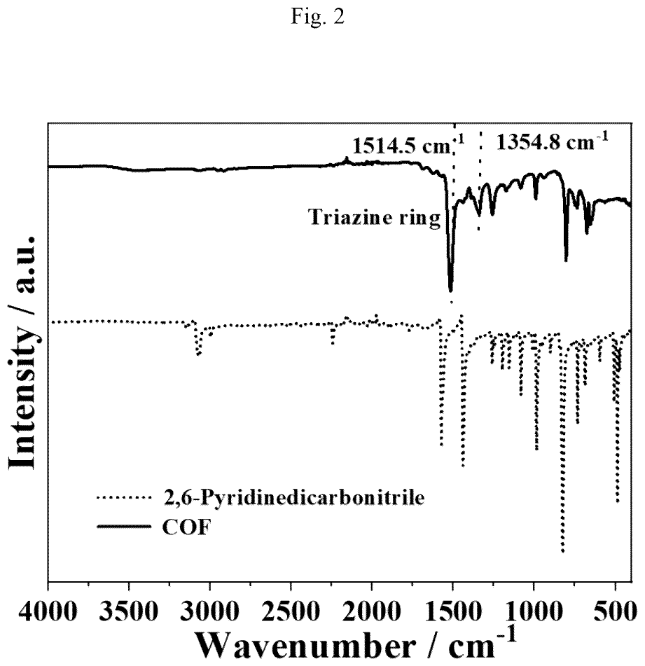

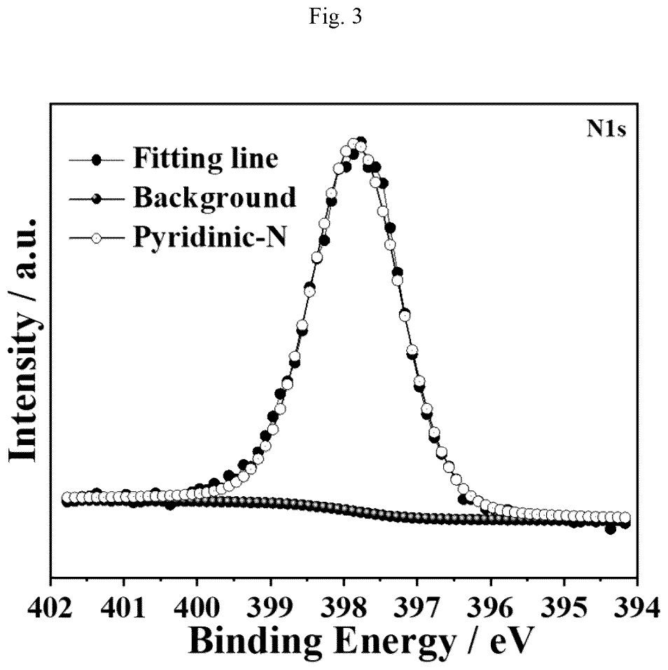

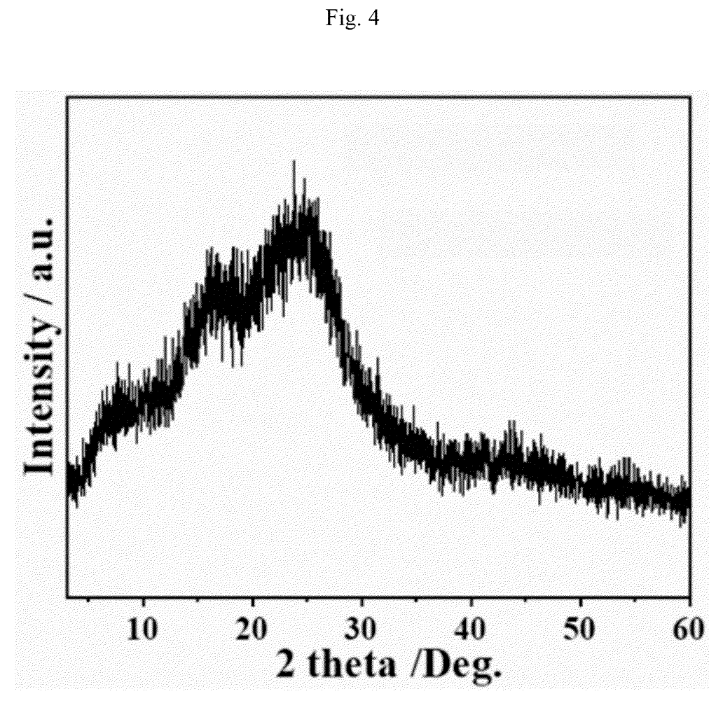

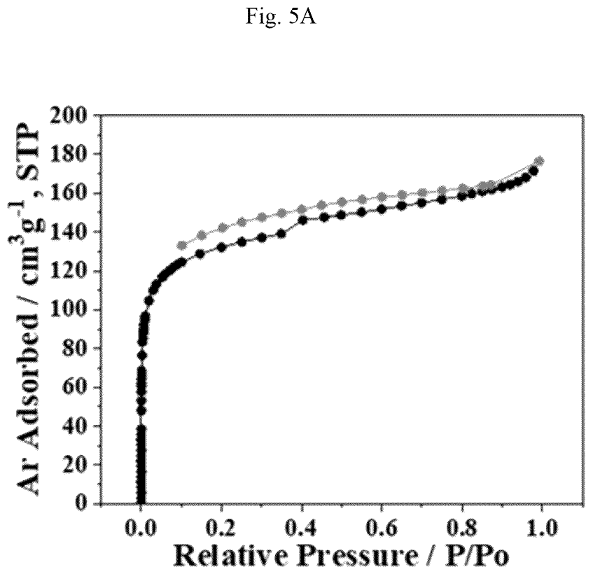

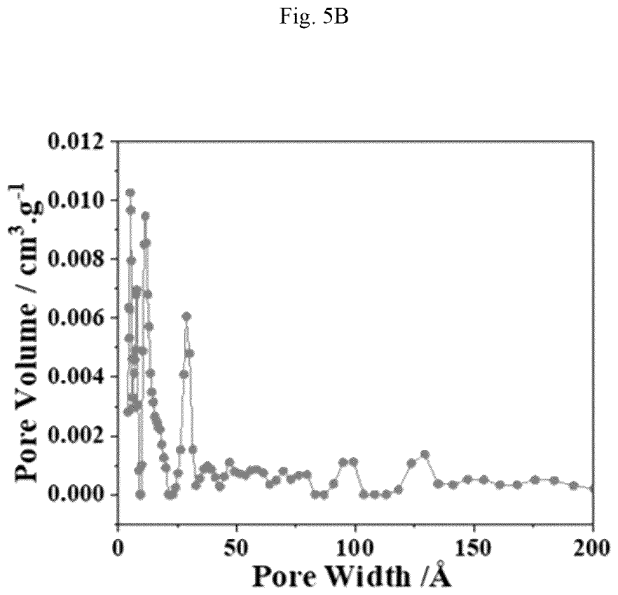

An example synthesis of a COF is shown in FIG. 1 where 2,6-pyridinedicarbonitrile was ionothermally polymerized in the presence of zinc chloride at temperatures ranging from 200° C. to 600° C. The FTIR spectra of the synthesized COF and 2,6-pyridinedicarbonitrile are shown in FIG. 2. The peaks at 1514.5 cm⁻¹ and 1354.8 cm⁻¹ in the synthesized COF material confirm the existence of triazine rings, which are absent in the starting material's spectra. This confirms successful synthesis of the COF structure shown in FIG. 1. X-ray photoelectron spectroscopy (XPS) spectra (N1s) of the synthesized COF material as shown in FIG. 3 indicates a single pyridinic N species corresponding to the triazine ring-structure is present. The X-ray diffraction spectra shown in FIG. 4 confirms the crystalline nature of the derived COF. The surface area and porosity of the synthesized COF was evaluated using Ar physisorption, as shown in FIGS. 5A and 5B. The surface area was evaluated using Brunauer-Emmett-Teller (BET) analysis and the porosity was evaluated using non-local density functional theory (NLDFT) analysis. The Ar physisorption confirms the synthesized COF is porous with high surface area, exhibiting surface areas of greater than 250 m² g⁻¹.

Carbonitrile compounds having two or more carbonitrile groups which may be polymerized as described above include heterocyclic aromatic compounds and hydrocarbon aromatic compounds. Exemplary heterocyclic aromatic carbonitrile compounds are shown in Table 1.

TABLE 1

| | |
|---|---|
| 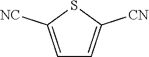 | (i) |
| 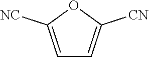 | (ii) |
| 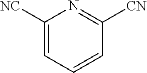 | (iii) |
| 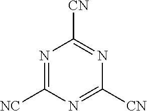 [SMILES: N#Cc1nc(C#N)nc(C#N)n1] | (iv) |
| 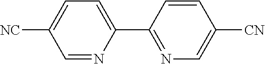 [SMILES: N#Cc1ccc(-c2ccc(C#N)cn2)nc1] | (v) |
| 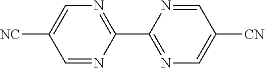 [SMILES: N#Cc1cnc(-c2ncc(C#N)cn2)nc1] | (vi) |
| 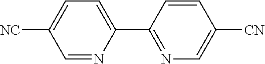 [SMILES: N#Cc1ccc(-c2ccc(C#N)cn2)nc1] | (vii) |
| 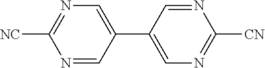 [SMILES: N#Cc1ncc(-c2cnc(C#N)nc2)cn1] | (viii) |
| 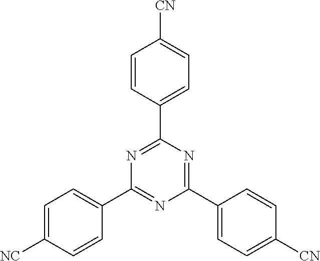 [SMILES: N#Cc1ccc(-c2nc(-c3ccc(C#N)cc3)nc(-c3ccc(C#N)cc3)n2)cc1] | (ix) |
| 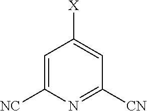 | (x) |
| 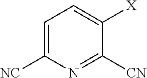 | (xi) |
| 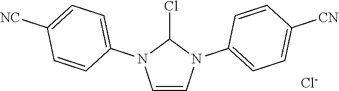 [SMILES: N#Cc1ccc(N2C=CN(c3ccc(C#N)cc3)C2Cl)cc1 ; [Cl-]] | (xii) |
| 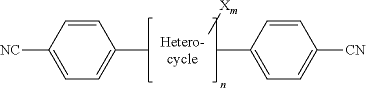 | (xiii) |

In Table 1, X each independently represent F, Cl, Br or I, n is a number from 1 to 4, m is a number from 1 to 12, and

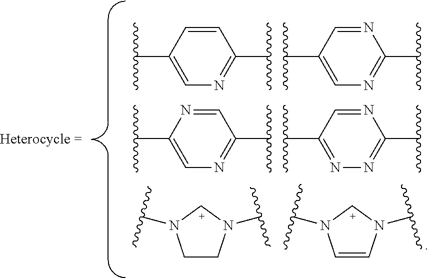

The list in Table 1 is not limiting and any aromatic heterocyclic compounds having two or more carbonitrile groups is included within the scope of this disclosure.

Exemplary hydrocarbon aromatic carbonitrile compounds are shown in Table 2.

TABLE 2

| | |
|---|---|
| 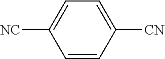 | (a) |
| 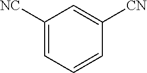 | (b) |
| 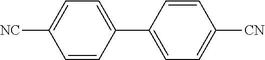 [SMILES: N#Cc1ccc(-c2ccc(C#N)cc2)cc1] | (c) |
| 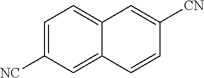 [SMILES: N#Cc1ccc2cc(C#N)ccc2c1] | (d) |
| 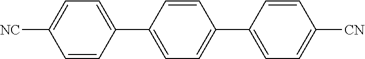 [SMILES: N#Cc1ccc(-c2ccc(-c3ccc(C#N)cc3)cc2)cc1] | (e) |
| 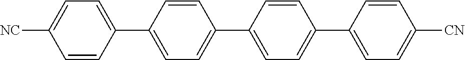 [SMILES: N#Cc1ccc(-c2ccc(-c3ccc(-c4ccc(C#N)cc4)cc3)cc2)cc1] | (f) |
| 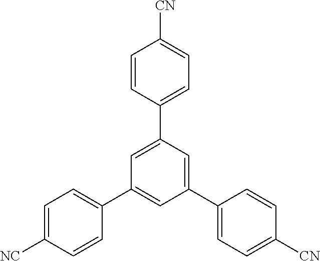 [SMILES: N#Cc1ccc(-c2cc(-c3ccc(C#N)cc3)cc(-c3ccc(C#N)cc3)c2)cc1] | (g) |
| 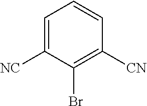 [SMILES: N#Cc1cccc(C#N)c1Br] | (h) |
| 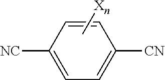 | (i) |
| 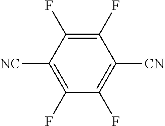 [SMILES: N#Cc1c(F)c(F)c(C#N)c(F)c1F] | (j) |
| 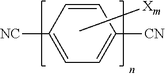 | (k) |
| 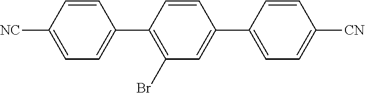 [SMILES: N#Cc1ccc(-c2ccc(-c3ccc(C#N)cc3)c(Br)c2)cc1] | (l) |
| 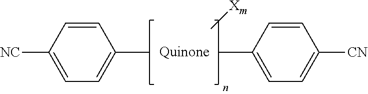 | (m) |
| 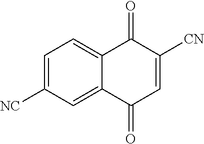 [SMILES: N#CC1=CC(=O)c2cc(C#N)ccc2C1=O] | (n) |

In Table 2, X each independently represent F, Cl, Br or I, n is a number from 1 to 4, m is a number from 1 to 16, and

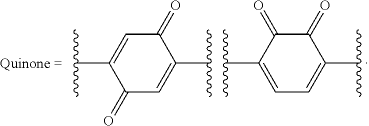

The list in Table 2 is not limiting and any hydrocarbon aromatic compounds having two or more carbonitrile groups is included within the scope of this disclosure.

The COF may be synthesized by polymerization of one carbonitrile compound selected from heterocyclic aromatic carbonitrile compounds and hydrocarbon aromatic carbonitrile compounds to obtain a homopolymer COF. Alternatively, two or more heterocyclic aromatic carbonitrile compounds, two or more hydrocarbon aromatic carbonitrile compounds or a mixture of heterocyclic aromatic carbonitrile compounds and hydrocarbon aromatic carbonitrile compounds may be polymerized to prepare porous three dimensional triazine COF networks according to the present disclosure. This flexibility allows for tailored design of the porous COF network to be obtained.

Noting that the microporous organic triazine polymer networks disclosed contain polyamine groups covalently bonded through an amino linkage to at least a portion of the aromatic monomer units, design of the COF and selection of the carbonitrile compounds employed includes recognition of a structure to which polyamine groups may be covalently bonded.

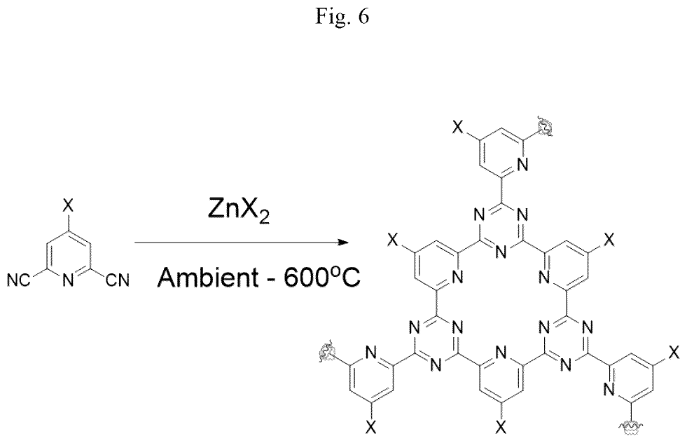

Thus, in one aspect of the disclosure carbonitrile compounds having halogen substituents which can be displaced by amine substitution are employed. FIG. 6 shows an exemplary synthesis of a COF having halogen groups. Halogen atoms include F, Cl, Br and I. Although ZnX₂ is indicated as the catalyst in FIG. 6 any of the acids described previously may be employed.

The conditions of this reaction are important because of the possible evolution of hydrogen halogenide gas, which reduces the halogen content in the resulting halogen-containing COF material. In this material, the halogenated functional group will be the attachment point for amine materials, so optimizing the amount of halogen functional groups is critical to optimizing the amine loading to be obtained in the COF.

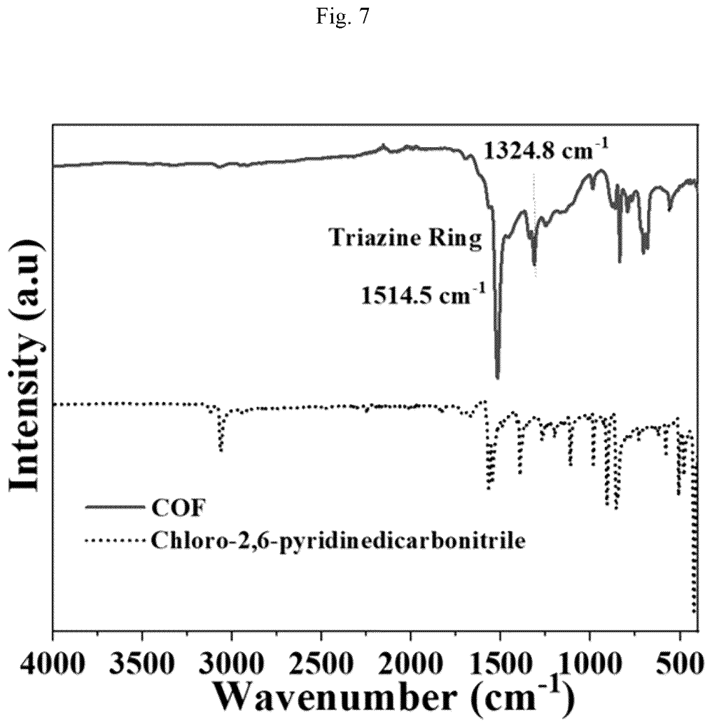

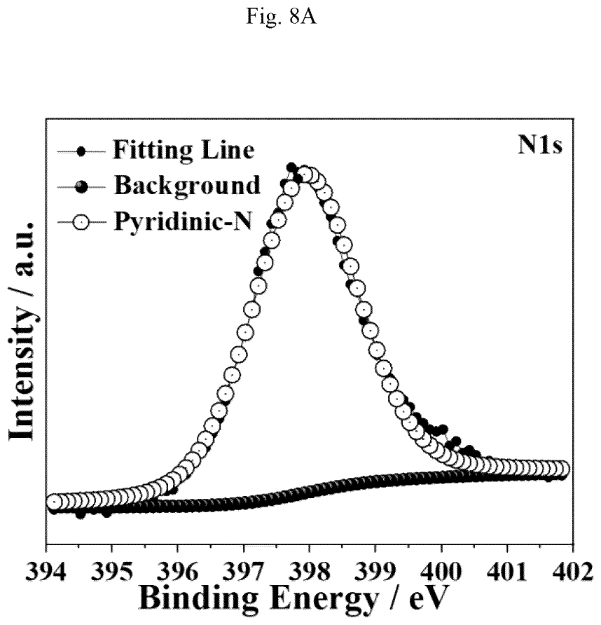

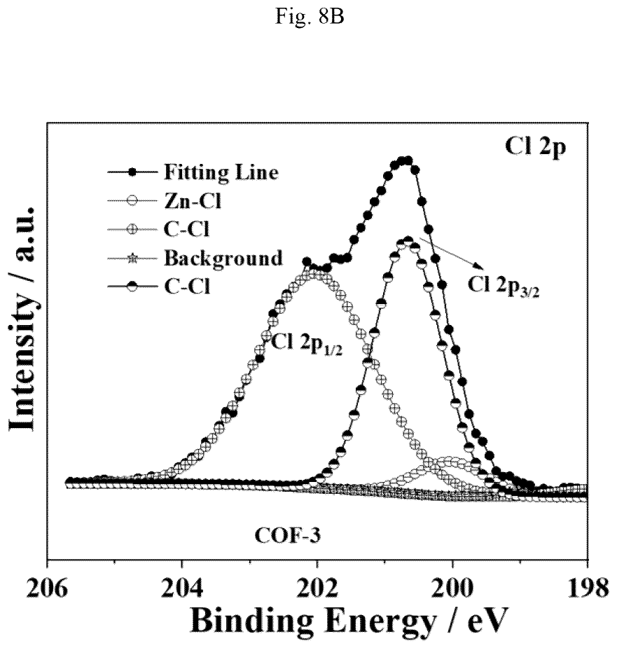

FIG. 7 shows the FTIR spectra of a COF obtained using 4-chloropyridine-2,6-dicarbonitrile as the carbonitrile compound polymerized in comparison to 4-chloropyridine-2,6-dicarbonitrile. The peaks at 1514.5 cm⁻¹ and 1324.8 cm⁻¹ in the synthesized COF material confirm the existence of triazine rings, which are absent in the starting material's spectra. This confirms the successful synthesis of a triazine-based covalent organic framework. N1s and C12p X-ray photoelectron spectra (XPS) of the synthesized halogen-containing COF material are shown in FIGS. 8A and 8B. The N1s XPS spectrum reveals a single nitrogen species is present in the COF, pyridinic nitrogen, which corresponds to the starting pyridine and the newly formed triazine ring structure. The C12p XPS spectrum highlights the significant presence of chlorine in the material, thus confirming the successful synthesis of a halogen-containing COF.

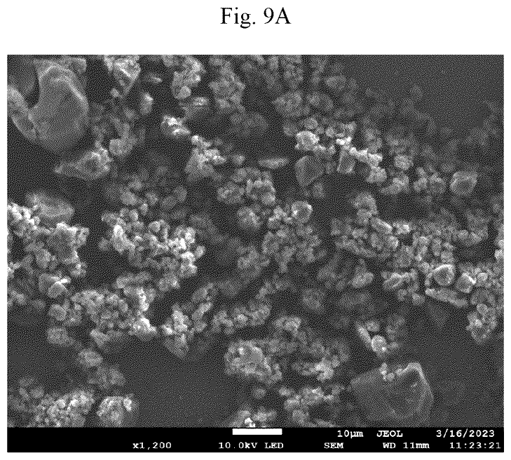

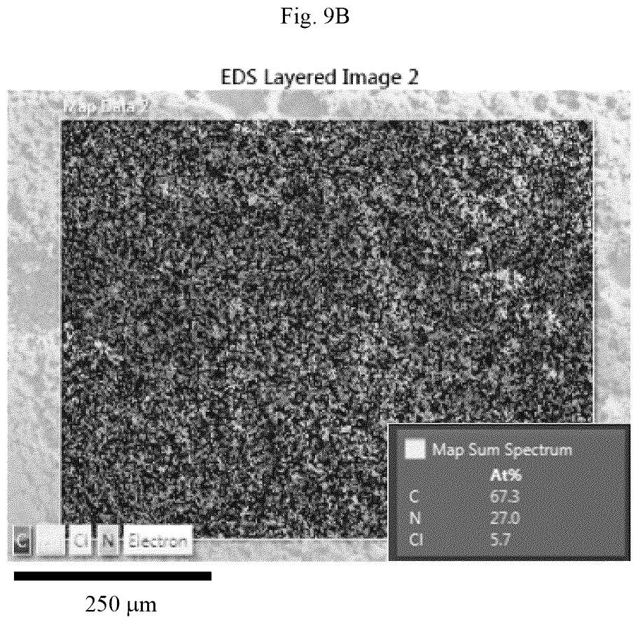

Scanning electron microscopy (SEM) images of the synthesized halogen-containing COF material, shown in FIG. 9A, reveal particles with sizes ranging from 3-20 μm. The chlorine map obtained by Scanning Electron Microscopy-Energy Dispersive x-ray Spectroscopy (SEM-EDX) of the material, shown in FIG. 9B, shows the elemental chlorine content of the material exceeds 7%. The chlorine content in the material can be tuned via synthetic method to result in concentrations ranging from 0.1% to 15% by mass of the COF. The chlorine in the material is evenly dispersed, as evidenced by the chlorine map obtained by SEM-EDX, shown in FIG. 9C.

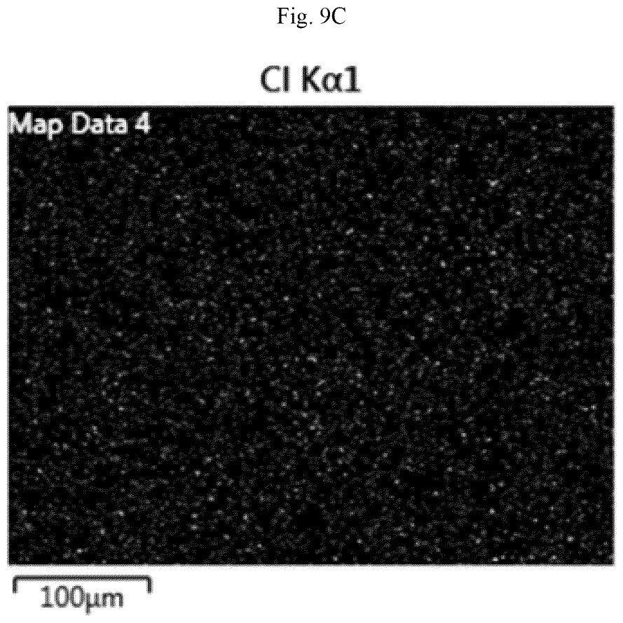

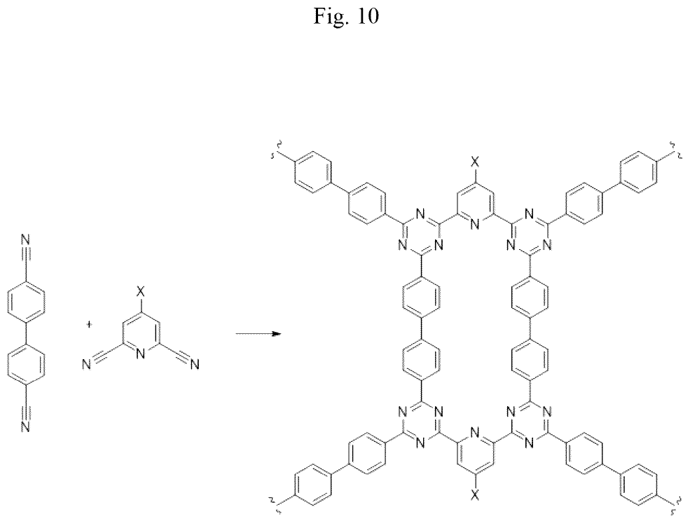

An example of synthesis of a mixed COF by copolymerization of a heterocyclic aromatic carbonitrile compound and hydrocarbon aromatic carbonitrile compound is shown in FIG. 10 employing 4,4′-biphenyldicarbonitrile and 4-chloropyridine-2,6-dicarbonitrile as starting materials.

To obtain a COF having polyamine groups covalently bonded through an amino linkage to at least a portion of the aromatic monomer units according to the present disclosure, it is necessary to graft polyamine groups onto at least a portion of the aromatic monomer units of the triazine polymer network. The inventors have accomplished preparing the amino grafts via synthesis methods including i) nucleophilic aromatic substitution of halogen groups, ii) Buchwald-Hartwig amination, and iii) oxidative nucleophilic hydrogen substitution.

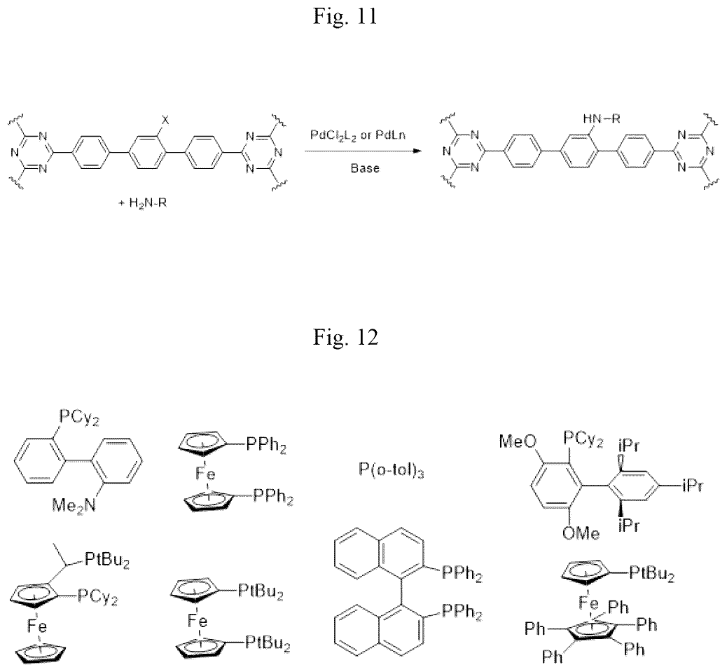

FIG. 11 shows an example of a Buchwald-Hartwig amination wherein a halogen on a ring carbon which is not activated for nucleophilic substitution is displaced with an amine compound. This reaction utilizes bases including, but not limited to, lithium tert-butoxide, sodium tert-butoxide and potassium tert-butoxide, and ligands including, but not limited to, those shown in FIG. 12. The ligands can be coordinated to palladium salts, which include but are not limited to, chlorides, nitrates, or acetates, or directly to palladium metal atoms.

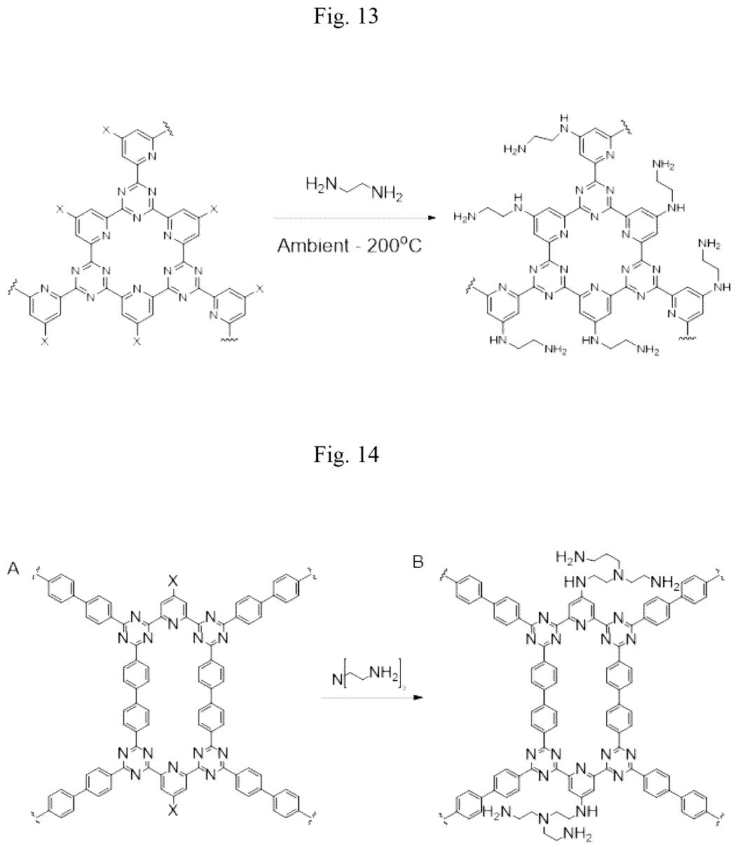

FIGS. 13 and 14 show examples of nucleophilic aromatic substitution of halogens (X=F, Cl, Br or I) which are located in positions para (including ortho) to a heteroatom activated for nucleophilic displacement. The amination via a nucleophilic aromatic substitution can be performed neat (no catalyst or solvent) or in a polar solvent, including, but not limited to, dimethylformamide, dimethylacetamide, dimethylsulfoxide, N-methylpyrrolidone, or sulfolane.

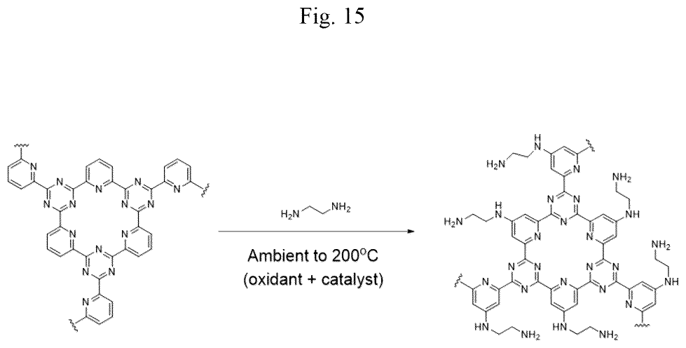

FIG. 15 shows an example of an oxidative nucleophilic hydrogen substitution. The oxidative nucleophilic hydrogen substitution reaction is performed in presence of an oxidant. The most frequently used oxidant is molecular oxygen; however other oxidants include copper oxides such as CuO and Cu₂O. The other catalysts of the process include, but are not limited to, copper acetate, silver nitrate, cobalt (salen), vanadyl salen hydrate; and metal salts of the formula MX where M can be, but are not limited to V. Cr, Mn, Fe, Co, Ni, Cu, Mo, Ru, Rh, Pd, Ag. W. Ce, U and X can be anions including, but not limited to, formate (HCOO⁻), acetate (CH₃COO⁻), trifluoroacetate (CF₃COO⁻), benzoate (C₆H₅COO⁻), other carboxylates (RCOO⁻), nitrate (NO₃⁻), F⁻, Cl⁻, Br⁻, I⁻, alkyl sulfonates such as methylsulfonate (CH₃SO₃⁻), perchlorate (ClO₄⁻), tetrafluoroborate (BF₄⁻), hexafluorophosphate (PF₆⁻), dihydrophosphate H₂PO₄⁻, hydroxide (OH⁻), oxide (O²⁻), sulfate (SO₄²⁻), carbonate (CO₂²⁻), hydrophosphate (HPO₄²⁻), and phosphate (PO₄³⁻).

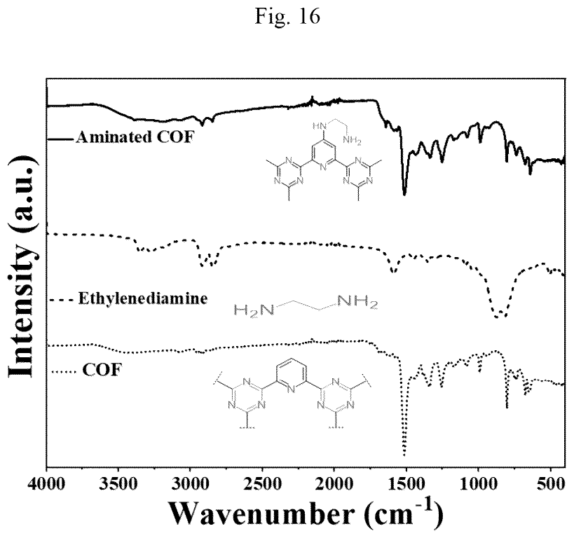

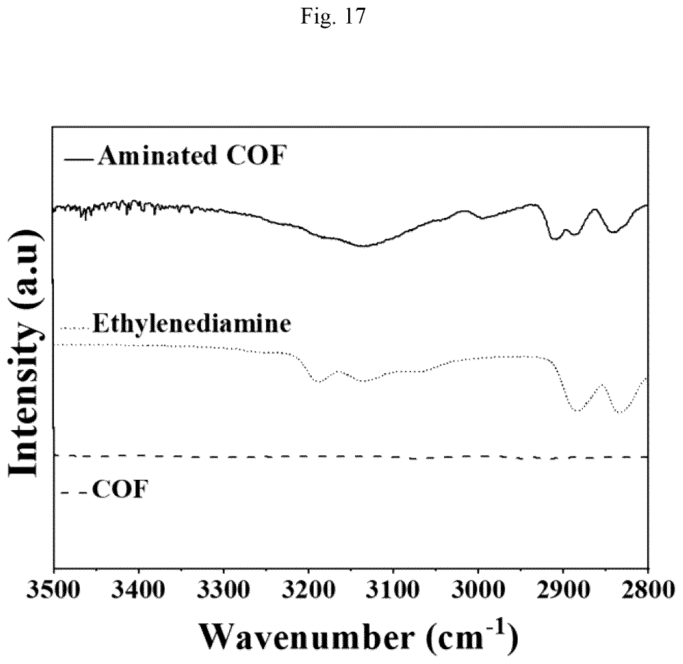

FIG. 16 shows FTIR spectra of the non-halogen COF of FIG. 15, ethylenediamine and the aminated COF product. The spectra indicate growth of the adsorption peaks in the 2830-2970 cm⁻¹ region and a broad absorption band in the 3200-3450 cm⁻¹ region in the infrared spectrum of the product, in comparison with the parent COF. These changes are consistent with the incorporation of C—H and N—H bonds of the ethylenediamine in the COF structure confirming amination. FIG. 17 shows the FTIR spectra of the non-halogen COF of FIG. 15, ethylenediamine and the aminated COF product. The change in absorption in the 2830-2970 cm⁻¹ and 3200-3450 cm⁻¹ regions corroborates the attachment of ethylenediamine molecules to the COF framework.

Descriptions of each of these amination reactions are provided in the Examples of this disclosure. These methods are known to one of skill in the art and description of each method may be found in the literature.

Although any polyamine compound may be employed for grafting to the COF, the polyamine may be represented by formula (I).

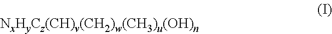

wherein x, y, z, v, w, u and n are numbers from 0 to 100. These amines can be linear, branched, or cyclic, and monomeric or polymeric and optionally, may be modified to include additional functional groups, including, but are not limited to, —OH, halogens, CO₂⁻, SO₃⁻, and SO₄⁻. Exemplary polyamines are shown in Table 3.

TABLE 3

| | |
|---|---|
| 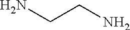 | a |
| 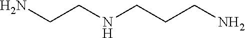 | b |
| 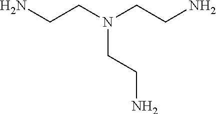 | c |
| 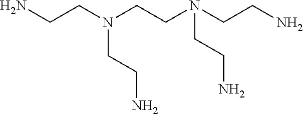 [SMILES: NCCN(CCN)CCN(CCN)CCN] | d |
| 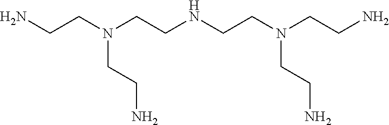 [SMILES: NCCN(CCN)CCNCCN(CCN)CCN] | e |
| 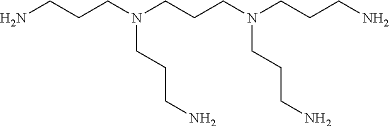 [SMILES: NCCCN(CCCN)CCCN(CCCN)CCCN] | f |
| 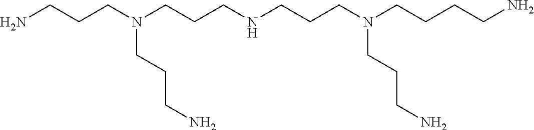 [SMILES: NCCCCN(CCCN)CCCNCCCN(CCCN)CCCN] | g |
| 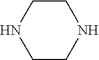 | h |
| 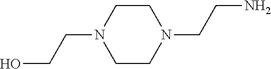 [SMILES: NCCN1CCN(CCO)CC1] | i |
| 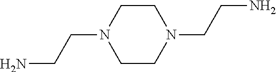 [SMILES: NCCN1CCN(CCN)CC1] | j |
| 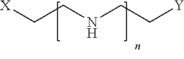 | k |
| 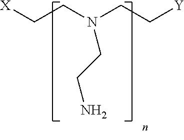 | l |
| 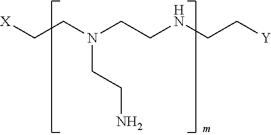 | m |
| 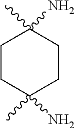 | n |
| 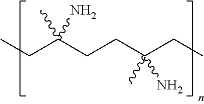 | o |
| 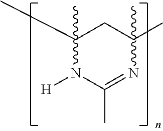 | p |

wherein in Table 3, subscripts n and m are numbers ranging from 1 to 100, and X and Y are each independently selected from H, halogen, OH⁻, CO₂⁻, SO₃⁻ and SO₄⁻.

Thus, in a first embodiment, the present disclosure provides a microporous organic triazine polymer network, comprising:
repeating triazine units copolymerized with hydrocarbon aromatic monomer units and/or heterocyclic aromatic monomer units arranged in a three dimensional porous network; and
polyamine groups covalently bonded through an amino linkage to at least a portion of the aromatic monomer units.

As previously described, i) the aromatic monomer units may consist of heterocyclic aromatic monomer units derived from heterocyclic compounds substituted with two or more carbonitrile groups, preferably at least a portion of the heterocyclic aromatic monomer units are derived from heterocyclic aromatic compounds substituted with three or more carbonitrile groups; ii) the aromatic monomer units consist of units derived from hydrocarbon aromatic compounds substituted with two or more carbonitrile groups, preferably at least a portion of the hydrocarbon aromatic monomer units are derived from hydrocarbon aromatic compounds substituted with three or more carbonitrile groups; or iii) the aromatic monomer units consist of hydrocarbon aromatic units derived from hydrocarbon aromatic compounds substituted with two or more carbonitrile groups and heterocyclic aromatic monomer units derived from heterocyclic compounds substituted with two or more carbonitrile groups, preferably, at least a portion of the hydrocarbon aromatic monomer units are derived from hydrocarbon aromatic compounds substituted with three or more carbonitrile groups.

Exemplary hydrocarbon aromatic compounds having two or more carbonitrile groups are shown in Table 2 and exemplary heterocyclic aromatic compounds are shown in Table 1. However, the examples shown in the Tables are not limiting and any heterocyclic aromatic compound having two or more carbonitrile groups or hydrocarbon aromatic compound having two or more carbonitrile groups are included within the scope of this disclosure.

The polyamine groups covalently bonded to at least a portion of the aromatic monomer units are derived from the group of compounds of Formula (I):

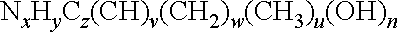

wherein x, y, z, v, w, u and n are numbers from 0 to 100. Exemplary polyamines (a) to (p) are provided in Table 3 as previously described.

The wide breadth of aromatic compounds having two or more carbonitrile groups and polyamines available for synthesis of the microporous organic triazine polymer network of the disclosure provides a wide range of materials to design and tailor the microporous organic triazine polymer network for specific utility and application. If two or more hydrocarbon aromatic compounds having two or more carbonitrile groups are copolymerized the molar ratio of the compounds may range from 1/99 to 99/1. Likewise, if two or more heteroaromatic aromatic compounds having two or more carbonitrile groups are copolymerized the molar ratio of the compounds may range from 1/99 to 99/1. Further, if a combination of a hydrocarbon aromatic compound having two or more carbonitrile groups and a heterocyclic aromatic compound having two or more carbonitrile groups is copolymerized, the molar ratio of the compounds may range from 1/99 to 99/1.

The content of the polyamine groups covalently bonded through amino linkage to at least a portion of the aromatic monomer units is from 1.0 mass % to 50 mass % preferably from 2.0 mass % to 40 mass % and most preferably from 3.0 mass % to 30 mass % of the total mass of the microporous organic triazine polymer network.

Multiple polyamine groups differing may be included and when multiple polyamine groups are present the total content is within the ranges described above.

As indicated in the figures the polyamine groups are directly covalently bonded through a N—C bond to a C of the ring structure of the aromatic monomer.

In one aspect of the first embodiment the aromatic monomer units of the microporous organic triazine polymer network comprise a heterocyclic aromatic monomer and the organic triazine polymer network further comprises a metal or metal ion coordinated and/or bonded with heteroatoms of the organic polymer network. The metal or metal ion is selected from the group consisting of monovalent, bivalent, trivalent, tetravalent, pentavalent and hexavalent metals.

The metal or metal ion is selected from the group consisting of transition metals, alkaline earth metals, aluminum, tin, lead, antimony and bismuth. Transition metals are preferred and iron, nickel, titanium, zirconium, chromium, zine, tin, lead copper and cobalt may be most preferred.

A content of the metal or metal ion is from 0.1 mass % to 1600 mass % preferably 0.5 mass % to 1300 mass % and most preferably 1.0 mass % to 1000 mass % of the total mass of the microporous organic triazine polymer network.

The metal containing microporous organic triazine polymer network may be prepared by treating the microporous organic triazine polymer network having polyamine groups covalently bonded with a solution or fine dispersion of the metal or metal salt. Although it is believed the metal or metal ion coordinates with the heteroatoms of the microporous organic triazine polymer network, it is also considered that coordination with the amine groups of the polyamine chains is possible.

In a second embodiment the present disclosure provides methods for preparing the microporous organic triazine polymer network having covalently bonded polyamine groups according to the first embodiment. In a first aspect, the method includes preparing an intimate mixture comprising an aromatic or aliphatic compound having two or more carbonitrile groups and/or a heterocyclic aromatic compound having two or more carbonitrile groups and an acid catalyst;
placing the intimate mixture in a dry, oxygen-free polymerization device;
polymerizing the hydrocarbon aromatic compound having two or more carbonitrile groups and/or the heterocyclic aromatic compound having two or more carbonitrile groups in the dry, oxygen-free polymerization device by heating the intimate mixture to a temperature of from 0° C. to 500° C.;
isolating the microporous organic triazine polymer;
reacting the microporous organic triazine polymer with a polyamine to covalently graft the polyamine to the triazine polymer network;
isolating the microporous organic triazine polymer network having covalently bonded polyamine groups.

The polymerization device may be an autoclave or other sealable reaction unit inert to the materials present in the polymerization mixture including a sealed glass vessel.

When the microporous organic triazine polymer comprises a labile halogen bonded to the organic triazine polymer, covalently grafting the polyamine to the triazine polymer is conducted by nucleophilic aromatic substitution displacement of the halogen with the polyamine. The nucleophilic aromatic substitution displacement is conducted at a temperature of from 0° C. to 200° C., optionally in an inert polar solvent, and/or optionally, in an environment free of an oxidant. According to the present disclosure, a labile halogen is a F, Cl, Br, or I bonded to a heterocyclic aromatic ring of the organic triazine polymer in a position ortho or para to the heteroatom.

When the microporous organic triazine polymer does not comprise a halogen bonded to the organic triazine polymer, covalently grafting the polyamine to the organic triazine polymer is conducted by oxidative nucleophilic substitution of an aromatic hydrogen in the presence of an oxidant and a catalyst. The oxidant may be oxygen and/or a copper oxide and the catalyst may be a transition metal salt. Description of this method is provided in the Examples

When the microporous organic triazine polymer comprises a quinone structure, covalently grafting the polyamine to the organic triazine polymer is conducted by nucleophilic addition of the polyamine to the quinone group.

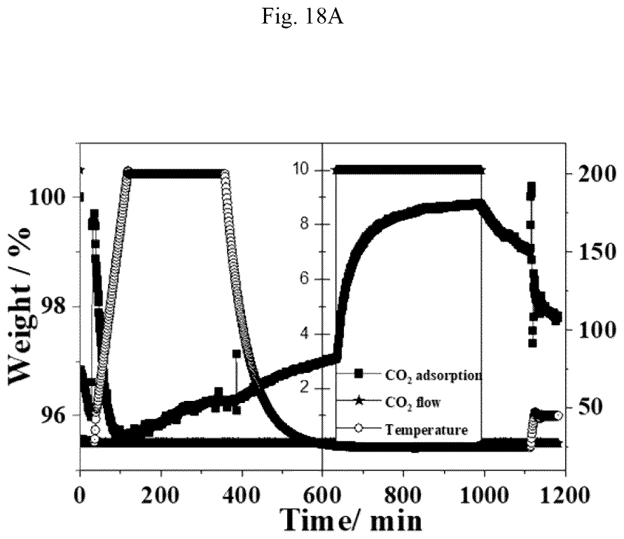

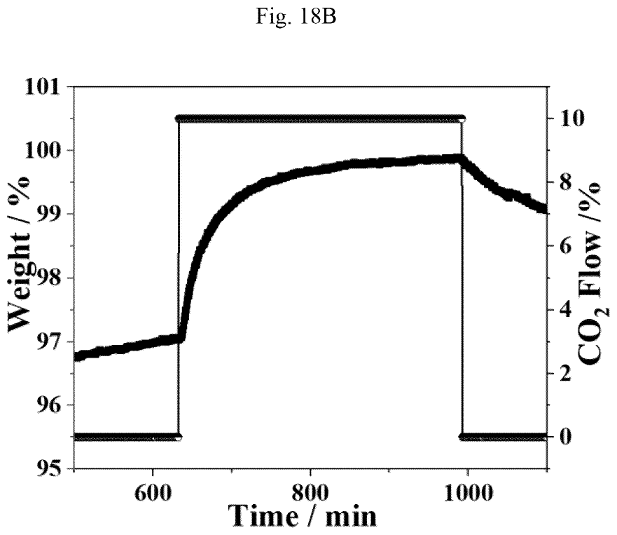

The microporous organic triazine polymer network according to the first embodiment of this disclosure is capable of CO₂ capture. The synthesized COF shown in FIG. 15 was evaluated for CO₂ capture under flue gas conditions (400 ppm CO₂-10 wt. % CO₂), as shown in FIGS. 18A and 18B. The COF was heated to between 50-300° C. to activate the sample and remove any ambiently adsorbed gases. Then, a mixture of gases containing CO₂ was passed over the sample, and the change in mass of the sample was recorded. The synthesized COF was successful in capturing CO₂, proving its efficacy as a CO₂ adsorbent.

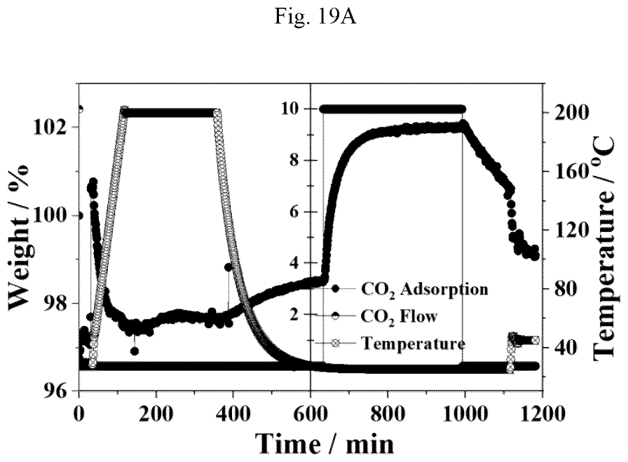

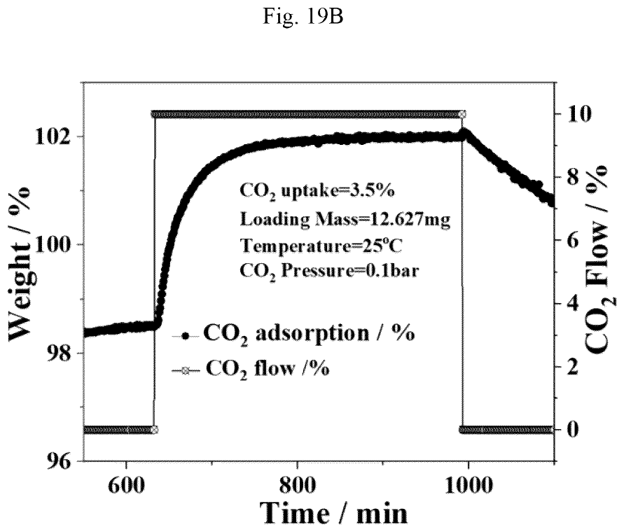

The synthesized COF shown in FIG. 15 was also evaluated for CO₂ capture using gas mixtures containing 400 ppm CO₂ to 10 wt. % CO₂, as shown in FIGS. 19A and 19B. The COF was heated to between 50-300° C. to activate the sample and remove any ambiently adsorbed gasses. Then a gas mixture containing CO₂ was passed over the sample, and the change in mass of the sample was recorded. The synthesized COF was successful in capturing 1-5 wt % CO₂.

The aminated COFs, described previously, were used for the capture of CO₂ from flue gas and directly from air (direct air capture, DAC). The corresponding materials syntheses, reactions with CO₂, and the analytical methods used to monitor the transformations were kept reasonably similar to those performed with MOF-appended amines described in the literature [R. Siegelinan, J. R. Long, J. Am. Chem. Soc., 2019, 141, 13171-13186]. Specifically, in the cited paper by R. Siegelman, J. Long et al., a diamine 2-(aminomethyl) piperidine (2-ampd) was appended to the metal sites in the Metal Organic Framework Mg₂(dobpdc). The resulting material, dubbed 2-ampd-Mg₂(dobpdc), was exposed to dry and wet carbon dioxide, transforming it into a carbamate.

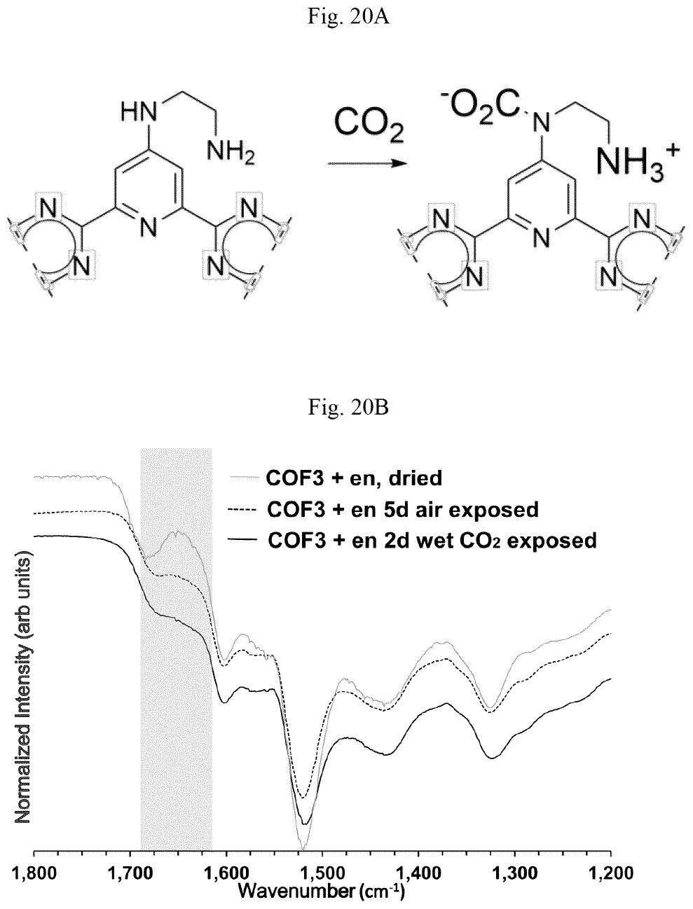

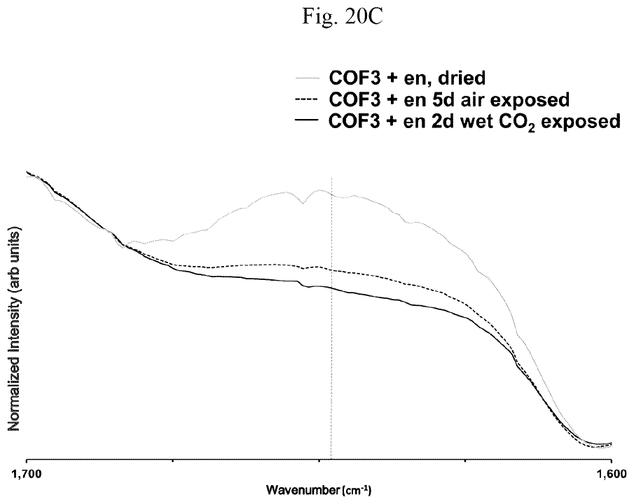

The scheme of the carbamate formation from the reaction of CO₂ with the aminated COF is illustrated in FIGS. 20A, 20B and 20C. To prepare a starting material, a sample of the amine-appended COF was heated in an argon flow to ensure that the material lost the carbon dioxide it could inadvertently adsorb from the air. Subsequently, that material was cooled down and analyzed by infrared spectroscopy while keeping it in an argon atmosphere to exclude contact with ambient CO₂. Its infrared spectrum is shown as the thin dotted line in FIG. 20B (COF+en, dried).

To test the ability of the aminated COF to adsorb CO₂ from the air, a fraction of the CO₂-free material was exposed to ambient air. The infrared spectrum of the air-exposed material is shown as the thick dotted line in FIG. 20B (COF+en, air exposed). Yet another fraction of the CO₂-free COF material was exposed to dry ice (solid CO₂). After a time, ranging from 1 minute to 7 days, that COF material was removed from exposure to the concentrated CO₂. During this process, the CO₂-exposed COF material was also exposed to water vapor, resulting in a CO₂— and moisture-exposed material. This material was also analyzed by infrared spectroscopy (solid line in FIG. 20B, COF+en, wet CO₂ exposed).

The changes in absorption intensity at 1648 cm⁻¹ have the same trends in both amine-MOF and aminated COF when both materials get exposed to CO₂. Specifically, as the aminated COF gets exposed to the ambient air, the bulge between the 1600 and 1680 cm⁻¹ becomes much smaller (thick dotted line, COF+en, air exposed in FIG. 20C). That change is consistent with the findings of Long et al., who observed decreased transmission of the 1648 cm⁻¹ peak of 2-ampd-Mg₂(dobpdc) exposed to dry CO₂, attributable to the formation of carbamates [R. Siegelman, J. R. Long, J. Am. Chem. Soc., 2019, 141, 13171-13186]. Finally, when the aminated COF gets exposed to wet, cold CO₂, the bulge completely disappears (FIG. 20C, solid line COF+en wet CO₂ exposed), corresponding to a further increase in the infrared adsorption in the region of NCOO⁻ (1648 cm⁻¹). Again, this change in the spectrum of the aminated COF is consistent with the findings of Long et al. (FIG. 20C, solid line, COF+en wet CO₂ exposed) that the presence of water increases the carbamate peak in an aminated material. This demonstrates that the increased concentration of CO₂ in presence of water increases the carbamate peak in the aminated COF.

Thus, in a third embodiment, the present disclosure provides a method for removal of carbon dioxide from a gaseous mixture, comprising:
preparing an adsorbent bed containing the microporous organic triazine polymer network of the first embodiment, wherein the microporous organic triazine polymer network is essentially free of adsorbed CO₂;
exposing a gaseous mixture containing carbon dioxide to the adsorbent bed to i) physisorb the CO₂ into a microporous structure of the microporous organic triazine polymer network, ii) chemisorb the CO₂ by reaction with amine groups of the polyamine groups within the microporous structure of the microporous organic triazine polymer network; or iii) physisorb and chemisorb the CO₂ into a microporous structure of the microporous organic triazine polymer network according to i) and ii). The gaseous mixture may be atmospheric air, an off gas from a combustion process, an off gas from an industrial process, or an exhaust gas of a fuel propelled vehicle.

The adsorbent bed may be heated to a temperature of from 30° C. to 220° C. preferably 40° C. to 200° C. and most preferably 50° C. to 180° C. optionally under flow of an inert gas to expel the physisorbed and chemisorbed CO₂ and return the microporous organic triazine polymer network to being essentially free of adsorbed CO₂.

The term “essentially free” means that 2% or less of the mass of the microporous organic triazine polymer network is due to the presence of CO₂. Preferably, the CO₂ content is less than 0.5% of the mass of the microporous organic triazine polymer network and most preferably, the CO₂ content is less than 0.1% of the mass of the microporous organic triazine polymer network.

The time for heating the adsorbent bed to return the microporous organic triazine polymer network to being essentially free of adsorbed CO₂ may be from 0.5 to 24 hours, preferably 0.5 to 18 hours and most preferably, 0.5 to 2 hours.

Because of the hydrolytic and oxidative stability of the microporous organic triazine polymer network of this disclosure exposing a gaseous mixture containing carbon dioxide to the adsorbent bed and heating the adsorbent bed having physisorbed and chemisorbed CO₂ to expel the physisorbed and chemisorbed CO₂ and return the microporous organic triazine polymer network to being essentially free of adsorbed CO₂ may be cyclically repeated for 10 to 1,000 cycles.

In a special aspect of this embodiment, the microporous organic triazine polymer network contains a metal coordinated or bonded to heteroatoms of the heteroaromatic monomer of the triazine polymer network as previously described.

In a fourth aspect, the present disclosure provides a device for removal of carbon dioxide from a gaseous mixture, comprising an adsorbent bed or multiple adsorbent beds containing the microporous organic triazine polymer network of the first embodiment. The device may be in the form of a removable flow-through module which can be inserted in a gas stream to capture CO₂ until capacity limit and then removed from the gas stream for rejuvenation by release of the capture CO₂ as described above. The module may be cyclically employed. Other devices may include a flow-through tube or column filled with a packing of an adsorbent material containing the microporous organic triazine polymer network of the first embodiment wherein a gas stream containing CO₂ is flowed through the packing and the CO₂ captured. Another device configuration may include an exposed surface containing the microporous organic triazine polymer network of the first embodiment wherein CO is passively captured from the environment to the exposed surface.

### EXAMPLES

### Example 1. Ionothermal Synthesis of COF by Polymerization of Terephthalonitrile with Zinc Chloride

Terephthalonitrile (TPN) and zinc dichloride, in a 1:0.1 to 1:50 mass ratio, were mixed in a low-moisture atmosphere inside of, but not limited to, dry room, glove bag, or dry box. The mixing could be done, but not limited to, hand-grinding with mortar and pestle, milling in a ball mill, or shaking in an acoustic shaker. That mixture was loaded into a Quartz tube sealed from one end such that no reactant mixture was left on the sides of the tubes at the point of the sealing. After that, the other end was vacuum-sealed. The tube was heated in an oven to 200-500° C. and kept at that temperature for 4-100 hr. After cooling, the tube was broken open; the reaction product was removed, washed successively with water, aqueous hydrochloric acid, water, acetone, isopropanol, pentane, or another appropriate combination of solvents, and then dried on the filter. When highly dry material was required, the product was additionally dried in a vacuum oven at 50-120° C. for 2-24 hours.

### Example 2. Ionothermal Synthesis of COF by Polymerization of Terephthalonitrile with Zinc Chloride

Terephthalonitrile and zine dichloride, in a 1:0.1 to 1:50 mass ratio, were mixed in a dry atmosphere. Then, in a dry, oxygen-free atmosphere, the mixture was loaded into a Teflon liner; the liner was hermetically closed and heated to 200-310° C. for 4-100 hr. After cooling, the liner was opened; the reaction product was removed, washed consequently with water, aqueous hydrochloric acid, water, acetone, isopropanol, pentane, or another appropriate combination of solvents, and then dried on the filter. When highly dry material was required, the product was additionally dried in a vacuum oven at 50-120° C. for 2-24 hours.

### Example 3. Ionothermal Synthesis of COF by Polymerization of Terephthalonitrile with Zinc Bromide

Terephthalonitrile (TPN) and zinc bromide, in a 1:0.1 to 1:50 mass ratio, were mixed in a low-moisture atmosphere inside of, but not limited to, dry room, glove bag, or dry box. The mixing could be done, but not limited to, hand-grinding with mortar and pestle, milling in a ball mill, or shaking in an acoustic mixer. That mixture was loaded into a Quartz tube sealed from one end such that no reactant mixture was left on the sides of the tubes at the point of the sealing. After that, the other end was vacuum-sealed.

The tube was heated to 200-500° C. for 4-100 hr. After cooling, the tube was broken open; the reaction product was removed, washed consequently with water, aqueous hydrochloric acid, water, acetone, isopropanol, pentane, or another appropriate combination of solvents, and then dried on the filter. When highly dry material was required, the product was additionally dried in a vacuum oven at 50-120° C. for 2-24 hours.

### Example 4. Ionothermal Synthesis of COF by Polymerization of Terephthalonitrile with Zinc Bromide

Terephthalonitrile (TPN) and zinc bromide, in a 1:0.1 to 1:50 mass ratio, were mixed in a low-moisture atmosphere inside of, but not limited to, dry room, glove bag, or dry box. The mixing could be done, but not limited to, hand-grinding with mortar and pestle, milling in a ball mill, or shaking in an acoustic mixer. Then, in a dry, oxygen-free atmosphere, the mixture was loaded into a Teflon liner; the liner was hermetically closed and heated to 200-310° C. for 4-100 hr. After cooling, the liner was opened; the reaction product was removed, washed consequently with water, aqueous hydrochloric acid, water, acetone, isopropanol, pentane, or another appropriate combination of solvents, and then dried on the filter. When highly dry material was required, the product was additionally dried in a vacuum oven at 50-120° C. for 2-24 hours.

### Example 5. Ionothermal Synthesis of COF by Polymerization of Pyridine-2,6-Dicarbonitrile with Zinc Chloride

Pyridine-2,6-dicarbonitrile and zinc chloride in a 1:0.1 to 1:50 mass ratio were mixed in a low-moisture atmosphere inside of, but not limited to, a dry room, glove bag, or dry box. The mixing could be done, but not limited to, hand-grinding with mortar and pestle, milling in a ball mill, or shaking in an acoustic mixer. That mixture was loaded into a Quartz tube sealed from one end, and the other end was vacuum sealed.

The tube was heated to 200-500° C. for 4-100 hr. After cooling, the tube was broken open; the reaction product was removed, washed consequently with water, aqueous hydrochloric acid, water, acetone, isopropanol, pentane, or another appropriate combination of solvents, and then dried on the filter. When highly dry material was required, the product was additionally dried in a vacuum oven at 50-120° C. for 2-24 hours.

### Example 6. Ionothermal Synthesis of COF by Polymerization of Benzene-1,3-Dicarbonitrile with Zinc Chloride

Benzene-1,3-dicarbonitrile and zinc chloride in a 1:0.1 to 1:50 mass ratio were mixed in a low-moisture atmosphere inside of, but not limited to, a dry room, glove bag, or dry box. The mixing could be done, but not limited to, hand-grinding with mortar and pestle, milling in a ball mill, or shaking in an acoustic mixer. Then, in a dry, oxygen-free atmosphere, the mixture was loaded into a Teflon liner; the liner was hermetically closed and heated to 200-310° C. for 4-100 hr. After cooling, the liner was opened; the reaction product was removed, washed consequently with water, aqueous hydrochloric acid, water, acetone, isopropanol, pentane, or another appropriate combination of solvents, and then dried on the filter. When highly dry material was required, the product was additionally dried in a vacuum oven at 50-120° C. for 2-24 hours.

### Example 7. Ionothermal Synthesis of COF by Polymerization of Pyridine-2,6-Dicarbonitrile with Zinc Bromide

Pyridine-2,6-dicarbonitrile and zinc chloride in a 1:0.1 to 1:50 mass ratio were mixed in a low-moisture atmosphere inside of, but not limited to, a dry room, glove bag, or dry box. The mixing could be done, but not limited to, hand-grinding with mortar and pestle, milling in a ball mill, or shaking in an acoustic shaker. That mixture was loaded into a Quartz tube sealed from one end, and the other end was vacuum sealed.

The tube was heated to 200-500° C. for 4-100 hr. After cooling, the tube was broken open; the reaction product was removed, washed consequently with water, aqueous hydrochloric acid, water, acetone, isopropanol, pentane, or another appropriate combination of solvents, and then dried on the filter. When highly dry material was required, the product was additionally dried in a vacuum oven at 50-120° C. for 2-24 hours.

### Example 8. Ionothermal Synthesis of COF by Polymerization of Pyridine-2,6-Dicarbonitrile with Cadmium Bromide

Pyridine-2,6-dicarbonitrile and cadmium bromide in a 1:0.1 to 1:50 mass ratio were mixed in a low-moisture atmosphere inside of, but not limited to, a dry room, glove bag, or dry box. The mixing could be done, but not limited to, hand-grinding with mortar and pestle, milling in a ball mill, or shaking in an acoustic mixer. Then, in a dry, oxygen-free atmosphere, the mixture was loaded into a Teflon liner; the liner was hermetically closed and heated to 200-310° C. for 4-100 hr. After cooling, the liner was opened; the reaction product was removed, washed consequently with water, aqueous hydrochloric acid, water, acetone, isopropanol, pentane, or another appropriate combination of solvents, and then dried on the filter. When highly dry material was required, the product was additionally dried in a vacuum oven at 50-120° C. for 2-24 hours.

### Example 9. Ionothermal Synthesis of COF by Polymerization of Biphenyl-4,4′-Dicarbonitrile with Zinc Bromide

Biphenyl-4,4′-dicarbonitrile and zinc bromide, in a 1:0.1 to 1:50 mass ratio, were mixed in a low-moisture atmosphere inside of, but not limited to, a dry room, glove bag, or dry box. The mixing could be done, but not limited to, hand-grinding with mortar and pestle, milling in a ball mill, or shaking in an acoustic mixer. Then, in a dry, oxygen-free atmosphere, the mixture was loaded into a Quartz tube sealed from one end, and the other end was vacuum sealed.

The tube was heated to 200-500° C. and kept at the high temperature for 4-100 hr. After cooling, the tube was broken open; the reaction product was removed, washed consequently with water, aqueous hydrochloric acid, water, acetone, isopropanol, pentane, or another appropriate combination of solvents, and then dried on the filter. When highly dry material was required, the product was additionally dried in a vacuum oven at 50-120° C. for 2-24 hours.

### Example 10. Ionothermal Synthesis of COF by Polymerization of Biphenyl-4,4′-Dicarbonitrile with Zinc Bromide

Biphenyl-4,4′-dicarbonitrile and zinc bromide, in a 1:0.1 to 1:50 mass ratio, were mixed in a low-moisture atmosphere inside of, but not limited to, a dry room, glove bag, or dry box. The mixing could be done, but not limited to, hand-grinding with mortar and pestle, milling in a ball mill, or shaking in an acoustic mixer. Then, in a dry, oxygen-free atmosphere, the mixture was loaded into a Teflon liner; the liner was hermetically closed and heated to 200-310° C. for 4-100 hr. After cooling, the liner was opened; the reaction product was removed, washed consequently with water, aqueous hydrochloric acid, water, acetone, isopropanol, pentane, or another appropriate combination of solvents, and then dried on the filter. When highly dry material was required, the product was additionally dried in a vacuum oven at 50-120° C. for 2-24 hours.

### Example 11. Ionothermal Synthesis of COF by Polymerization of Triazine-2,4,6-Tricarbonitrile with Cadmium Bromide

Triazine-2,4,6-tricarbonitrile and cadmium bromide, in a 1:0.1 to 1:50 mass ratio, were mixed in a low-moisture atmosphere inside of, but not limited to, a dry room, glove bag, or dry box. The mixing could be done, but not limited to, hand-grinding with mortar and pestle, milling in a ball mill, or shaking in an acoustic mixer. Then, in a dry, oxygen-free atmosphere, the mixture was loaded into a Teflon liner; the liner was hermetically closed and heated to 200-310° C. for 4-100 hr. After cooling, the liner was opened; the reaction product was removed, washed consequently with water, aqueous hydrochloric acid, water, acetone, isopropanol, pentane, or another appropriate combination of solvents, and then dried on the filter. When highly dry material was required, the product was additionally dried in a vacuum oven at 50-120° C. for 2-24 hours.

### Example 12. Ionothermal Synthesis of a Halogenated COF by Polymerization of 2-Chloroisophthalo-Nitrile with Zinc Chloride

The monomer. 2-chloroisophthalonitrile, and zinc chloride, in a 1:0.1 to 1:50 mass ratio, were mixed in a low-moisture atmosphere inside of, but not limited to, a dry room, glove bag, or dry box. The mixing could be done, but not limited to, hand-grinding with mortar and pestle, milling in a ball mill, or shaking in an acoustic mixer. Then, in a dry, oxygen-free atmosphere, the mixture was loaded into a Quartz tube sealed from one end, and the other end was vacuum sealed.

The tube was heated to 200-500° C. for 4-100 hr. After cooling, the tube was broken open; the reaction product was removed, washed consequently with water, aqueous hydrochloric acid, water, acetone, isopropanol, pentane, or another appropriate combination of solvents, and then dried on the filter. When highly dry material was required, the product was additionally dried in a vacuum oven at 50-120° C. for 2-24 hours.

### Example 13. Ionothermal Synthesis of a Halogenated COF by Polymerization of 4-Chloropyridine-2,6-Dicarbonitrile with Zinc Chloride

The monomer, 4-chloropyridine-2,6-dicarbonitrile, and zine chloride, in 1:1 to 1:10 weight ratio, were mixed in a dry atmosphere. Then, in a dry, oxygen-free atmosphere, the mixture was loaded into a Teflon liner; the liner was hermetically closed and heated to 200-310° C. for 4-100 hr. After cooling, the liner was open: the reaction product was removed, washed consequently with water, aqueous hydrochloric acid, water, acetone, isopropanol, pentane, or another appropriate combination of solvents, and then dried on the filter. When highly dry material was required, the product was additionally dried in a vacuum oven at 50-120° C. for 2-24 hours.

### Example 14. Ionothermal Synthesis of a Halogenated COF by Polymerization of 4-Chloropyridine-2,6-Dicarbonitrile with Zine Bromide

The monomer, 4-chloropyridine-2,6-dicarbonitrile, and zinc bromide, in a 1:0.1 to 1:50 mass ratio, were mixed in a low-moisture atmosphere inside of, but not limited to, a dry room, glove bag, or dry box. The mixing could be done, but not limited to, hand-grinding with mortar and pestle, milling in a ball mill, or shaking in an acoustic mixer. Then, in a dry, oxygen-free atmosphere, the mixture was loaded into a Quartz tube sealed from one end, and the other end was vacuum sealed.

The tube was heated to 200-500° C. for 4-100 hr. After cooling, the tube was broken open: the reaction product was removed, washed consequently with water, aqueous hydrochloric acid, water, acetone, isopropanol, pentane, or another appropriate combination of solvents, and then dried on the filter. When highly dry material was required, the product was additionally dried in a vacuum oven at 50-120° C. for 2-24 hours.

### Example 15. Ionothermal Synthesis of a Halogenated COF by Polymerization of 4-Chloropyridine-2,6-Dicarbonitrile with Zinc Bromide

The monomer, 4-chloropyridine-2,6-dicarbonitrile, and zinc bromide, in a 1:0.1 to 1:50 mass ratio, were mixed in a low-moisture atmosphere inside of, but not limited to, a dry room, glove bag, or dry box. The mixing could be done, but not limited to, hand-grinding with mortar and pestle, milling in a ball mill, or shaking in an acoustic mixer. Then, in a dry, oxygen-free atmosphere, the mixture was loaded into a Teflon liner; the liner was hermetically closed and heated to 200-310° C. for 4-100 hr. After cooling, the liner was open; the reaction product was removed, washed consequently with water, aqueous hydrochloric acid, water, acetone, isopropanol, pentane, or another appropriate combination of solvents, and then dried on the filter. When highly dry material was required, the product was additionally dried in a vacuum oven at 50-120° C. for 2-24 hours.

### Example 16. Ionothermal Synthesis of a Mixed Halogenated COF by Copolymerization of 4-Chloropyridine-2,6-Dicarbonitrile with Biphenyl-4,4′-Dicarbonitrile in Zinc Bromide

The monomers, 4-chloropyridine-2,6-dicarbonitrile and biphenyl-4,4′-dicarbonitrile, were mixed in a molar ratio varying from 1:30 to 30:1. That mixture was mixed with zine bromide, in a 1:0.1 to 1:50 mass ratio, were mixed in a low-moisture atmosphere inside of, but not limited to, a dry room, glove bag, or dry box. The mixing could be done, but not limited to, hand-grinding with mortar and pestle, milling in a ball mill, or shaking in an acoustic mixer. Then, in a dry, oxygen-free atmosphere, the mixture was loaded into a Quartz tube sealed from one end, and the other end was vacuum sealed.

The tube was heated to 200-500° C. for 4-100 hr. After cooling, the tube was broken open; the reaction product was removed, washed consequently with water, aqueous hydrochloric acid, water, acetone, isopropanol, pentane, or another appropriate combination of solvents, and then dried on the filter. When highly dry material was required, the product was additionally dried in a vacuum oven at 50-120° C. for 2-24 hours.

### Example 17. Ionothermal Synthesis of a Mixed Halogenated COF by Copolymerization of 2,4,6-Trichlorobenzene-1,3,5-Tricarbonitrile with Biphenyl-4,4′-Dicarbonitrile in Zine Bromide

The monomers, 2,4,6-trichlorobenzene-1,3,5-tricarbonitrile and biphenyl-4,4′-dicarbonitrile, were mixed in a molar ratio varying from 1:30 to 30:1. That mixture was mixed with zinc bromide, in a 1:0.1 to 1:50 mass ratio, were mixed in a low-moisture atmosphere inside of, but not limited to, a dry room, glove bag, or dry box. The mixing could be done, but not limited to, hand-grinding with mortar and pestle, milling in a ball mill, or shaking in an acoustic mixer. Then, in a dry, oxygen-free atmosphere, the mixture was loaded into a Quartz tube sealed from one end, and the other end was vacuum sealed.

The tube was heated to 200-500° C. for 4-100 hr. After cooling, the tube was broken open; the reaction product was removed, washed consequently with water, aqueous hydrochloric acid, water, acetone, isopropanol, pentane, or another appropriate combination of solvents, and then dried on the filter. When highly dry material was required, the product was additionally dried in a vacuum oven at 50-120° C. for 2-24 hours.

### Example 18. Ionothermal Synthesis of a Mixed Halogenated COF by Copolymerization of 2,4,6-Trichloro-1,3,5-Triazine with Biphenyl-4,4-Dicarbonitrile in Zinc Bromide

The monomers, 2,4,6-trichloro-1,3,5-triazine and biphenyl-4,4′-dicarbonitrile, were mixed in a molar ratio varying from 1:30 to 30:1. That mixture was mixed with zinc bromide, in a 1:0.1 to 1:50 mass ratio, were mixed in a low-moisture atmosphere inside of, but not limited to, a dry room, glove bag, or dry box. The mixing could be done, but not limited to, hand-grinding with mortar and pestle, milling in a ball mill, or shaking in an acoustic mixer. Then, in a dry, oxygen-free atmosphere, the mixture was loaded into a Quartz tube sealed from one end, and the other end was vacuum sealed.

The tube was heated to 200-500° C. for 4-100 hr. After cooling, the tube was broken open; the reaction product was removed, washed consequently with water, aqueous hydrochloric acid, water, acetone, isopropanol, pentane, or another appropriate combination of solvents, and then dried on the filter. When highly dry material was required, the product was additionally dried in a vacuum oven at 50-120° C. for 2-24 hours.

### Example 19. Ionothermal Synthesis of a Mixed Halogenated COF by Copolymerization of 4-Chloropyridine-2,6-Dicarbonitrile with 4,4′-Dicyanoterphenyl in Zinc Bromide-Cadmium Bromide Mixture

The monomers, 4-chloropyridine-2,6-dicarbonitrile and 4,4′-dieyanoterphenyl, were mixed in a molar ratio varying from 1:30 to 30:1. Separately, zinc bromide and cadmium bromide were mixed in a molar ratio varying from 1:30 to 30:1. Those mixtures were mixed with each other in a 1:0.1 to 1:50 mass ratio, in a dry atmosphere. The resulting three-component mixture was loaded into a Teflon liner; the liner was hermetically closed and heated in an oven to 200-310° C. for 4-100 hr. After cooling, the liner was opened; the reaction product was removed, washed consequently with water, aqueous hydrochloric acid, water, acetone, isopropanol, pentane, or another appropriate combination of solvents, and then dried on the filter. When highly dry material was required, the product was additionally dried in a vacuum oven at 50-120° C. for 2-24 hours.

### Example 20. Ambient-Temperature COF Synthesis by Polymerization of Biphenyl-4,4′-Dicarbonitrile in a Chloroform-Triflic Acid Mixture

Biphenyl-4,4′-dicarbonitrile, was dispersed in a halogenated solvent, which could be but not limited, to dichloromethane or chloroform, so that the biphenyl-4,4′-dicarbonitrile: solvent mass ratio varied from 1:1 up to 1:100. Optionally, the resulting solution could be cooled. Optionally, the resulting solution, which might have insoluble biphenyl-4,4′-dicarbonitrile, could be stirred. To that solution, triflic acid is added in molar ratios biphenyl-4,4′-dicarbonitrile:triflic acid varying from 1:0.1 to 1:100. Optionally, the solution, which might contain insoluble components, can be stirred during the addition. Optionally, the triflic acid can be pre-cooled before the addition. After the addition, the solution is allowed to warm up to ambient temperature and stay at that temperature for 1-48 hours on stirring. The ensuing reaction leads to the formation of a chloroform-insoluble solid. Optionally, water or ice can be added at the end of the reaction. That solid is filtered, rinsed with water and, optionally, organic solvents, and then dried.

The above description is presented to enable a person skilled in the art to make and use the embodiments of the present disclosure and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown but is to be accorded the widest scope consistent with the principles and features disclosed herein. In this regard, certain embodiments within the invention may not show every benefit of the invention, considered broadly.

1. A microporous organic triazine polymer network, comprising:
repeating triazine units copolymerized with hydrocarbon aromatic monomer units and/or heterocyclic aromatic monomer units arranged in a three dimensional porous network; and
polyamine groups covalently bonded through an amino linkage to at least a portion of the aromatic monomer units.

2. The microporous organic triazine polymer network according to claim 1 wherein the aromatic monomer units consist of heterocyclic aromatic monomer units derived from heterocyclic compounds substituted with two or more carbonitrile groups.

3. The microporous organic triazine polymer network according to claim 2 wherein at least a portion of the heterocyclic aromatic monomer units are derived from heterocyclic compounds substituted with three or more carbonitrile groups.

4. The microporous organic triazine polymer network according to claim 2, wherein the heterocyclic aromatic monomer units are derived from compounds selected from the group consisting of (i) to (xiii): 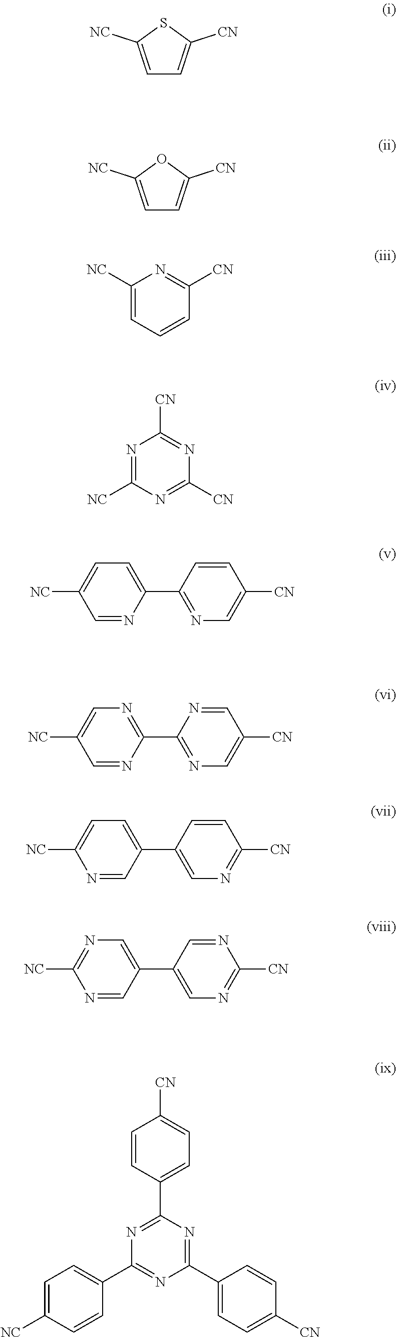 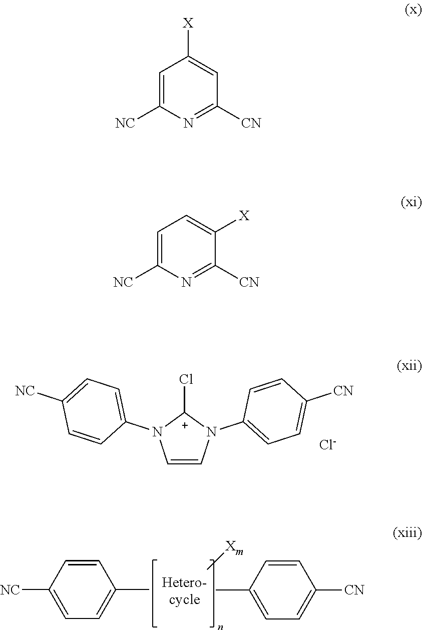
wherein
X each independently is F, Cl, Br or I,
n is a number from 1 to 12,
m is a number from 1 to 4,
and

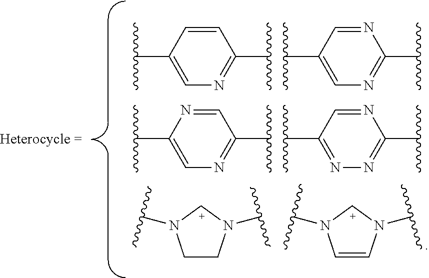

5. The microporous organic triazine polymer network according to claim 1 wherein the aromatic monomer units consist of units derived from hydrocarbon aromatic compounds substituted with two or more carbonitrile groups.

6. The microporous organic triazine polymer network according to claim 5, wherein at least a portion of the hydrocarbon aromatic monomer units are derived from hydrocarbon aromatic compounds substituted with three or more carbonitrile groups.

7. The microporous organic triazine polymer network according to claim 5, wherein the hydrocarbon aromatic monomer units are derived from compounds selected from the group consisting of formulas (a)-(n): 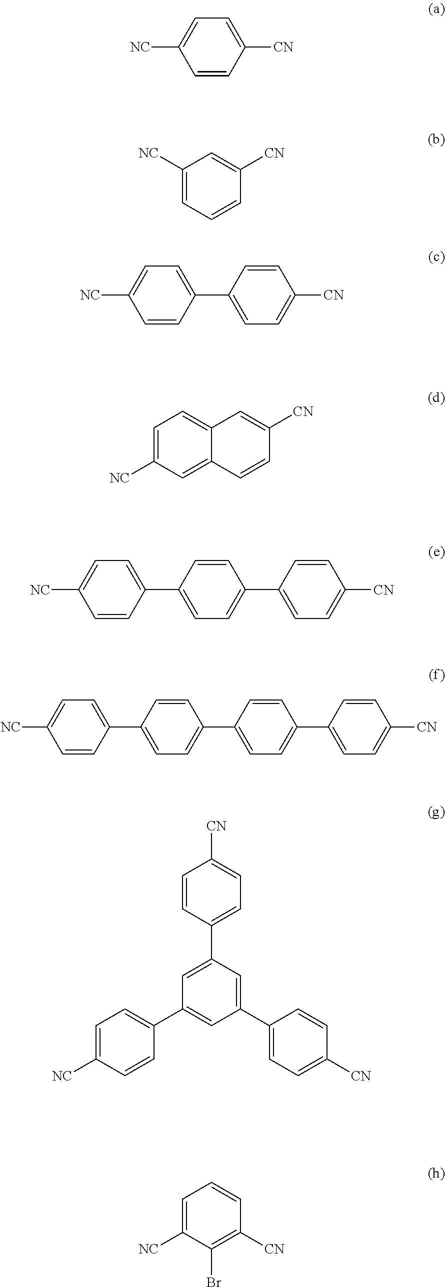 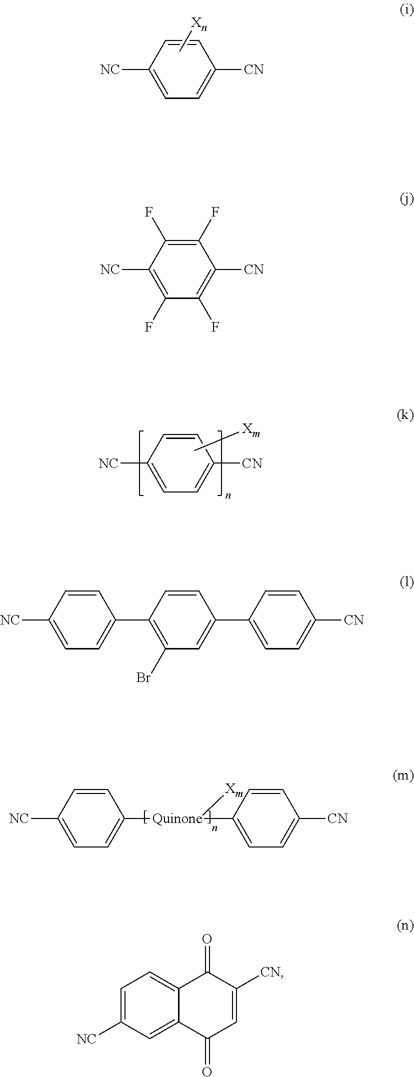
wherein
X each independently is F, Cl, Br or I,
n is a number from 1 to 4,
m is a number from 1 to 16,

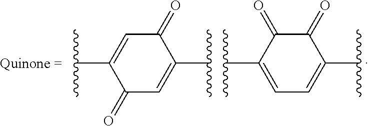

8. The microporous organic triazine polymer network according to claim 1, wherein the aromatic monomer units consist of hydrocarbon aromatic units and heterocyclic aromatic monomer units.

9. The microporous organic triazine polymer network according to claim 1 wherein the polyamine groups covalently bonded to at least a portion of the aromatic monomer units are derived from the group of compounds consisting of (a) to (p) 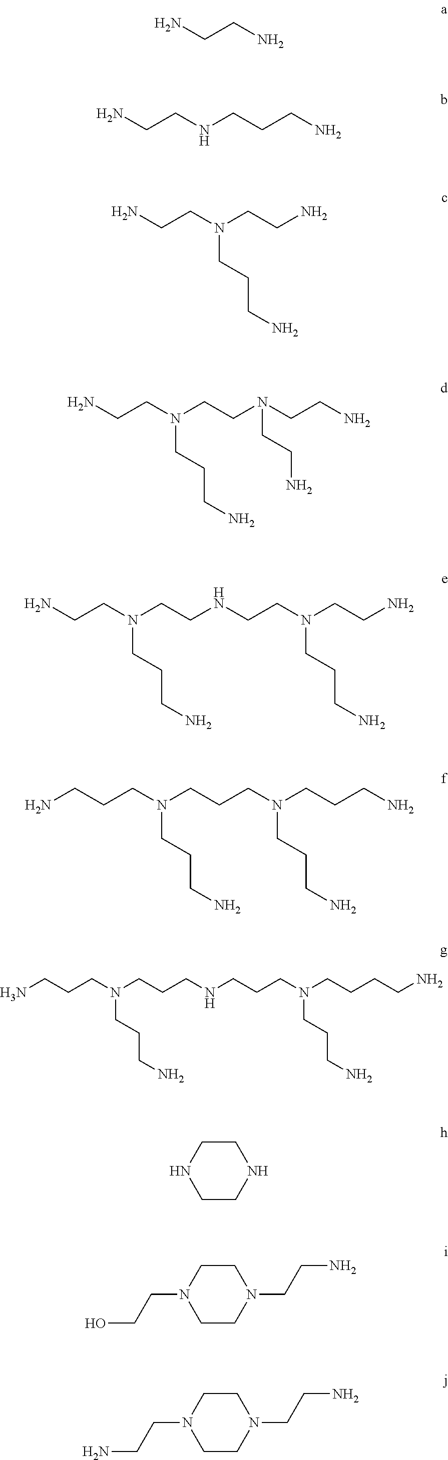 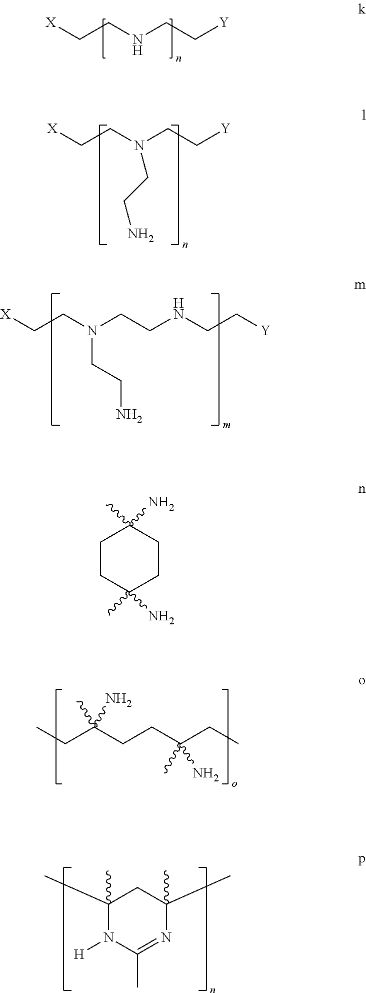
wherein subscripts n and m are numbers ranging from 1 to 50, and
X and Y are each independently selected from H, halogen, CO₂, OH, SO₃; and SO₄.

10. The microporous organic triazine polymer network according to claim 1, wherein a content of the polyamine groups covalently bonded through amino linkage to at least a portion of the aromatic monomer units is from 1.0 mass % to 50 mass % of the total mass of the microporous organic triazine polymer network.

11. The microporous organic triazine polymer network according to claim 1 wherein the polyamine groups covalently bonded to at least a portion of the aromatic monomer units are covalently bonded through an amine N directly bonded to a C of the monomer unit.

12. The microporous organic triazine polymer network according to claim 1, wherein the aromatic monomer units comprise a heterocyclic aromatic monomer and the organic polymer network further comprises a metal or metal ion coordinated and/or bonded with heteroatoms of the organic polymer network.

13. The microporous organic triazine polymer network according to claim 12, wherein the metal or metal ion is selected from the group consisting of monovalent, bivalent, trivalent, tetravalent, pentavalent and hexavalent metals.

14. The microporous organic triazine polymer network according to claim 12, wherein the metal or metal ion is selected from the group consisting of transition metals, alkaline earth metals, aluminum, tin, lead, antimony and bismuth.

15. The microporous organic triazine polymer network according to claim 12, wherein a content of the metal or metal ion is from 0.1 mass % to 10 mass % of the total mass of the microporous organic triazine polymer network.

16. A method to prepare a microporous organic triazine polymer network having covalently bonded polyamine groups, comprising:
preparing an intimate mixture comprising a hydrocarbon aromatic compound having two or more carbonitrile groups and/or a heterocyclic aromatic compound having two or more carbonitrile groups and an acid catalyst;
placing the intimate mixture in a dry, oxygen-free polymerization device;
polymerizing the hydrocarbon aromatic compound having two or more carbonitrile groups and/or the heterocyclic aromatic compound having two or more carbonitrile groups in the dry, oxygen-free polymerization device by heating the intimate mixture to a temperature of from 200-500° C.;
isolating the microporous organic triazine polymer;
reacting the microporous organic triazine polymer with a polyamine to covalently graft the polyamine to the triazine polymer network;
isolating the microporous organic triazine polymer network having covalently bonded polyamine groups.

17. The method according to claim 16, wherein the microporous organic triazine polymer comprises a labile halogen bonded to the organic triazine polymer, and covalently grafting the polyamine to the triazine polymer is conducted by nucleophilic aromatic substitution of the halogen with the polyamine.

18. The method according to claim 17, wherein the nucleophilic aromatic substitution displacement is conducted at a temperature of from 20° C. to 200° C., optionally in an inert polar solvent, and/or optionally, in an environment free of an oxidant.

19. The method according to claim 17, wherein the labile halogen is a F, Cl, Br, or I bonded to a heterocyclic aromatic ring of the organic triazine polymer.

20. The method according to claim 16, wherein the microporous organic triazine polymer comprises a halogen bonded to a hydrocarbon aromatic ring of the organic triazine polymer, and
covalently grafting the polyamine to the triazine polymer is conducted by displacement of the halogen with the polyamine in the presence of an alkoxide base, ligand, and a palladium compound.

21. The method according to claim 16, wherein the microporous organic triazine polymer does not comprises a halogen bonded to the organic triazine polymer, and
covalently grafting the polyamine to the organic triazine polymer is conducted by oxidative nucleophilic substitution of an aromatic hydrogen in the presence of an oxidant and a catalyst.

22. The method according to claim 21, wherein the oxidant is oxygen and/or a copper oxide and the catalyst is a transition metal salt.

23. The method according to claim 16, wherein the microporous organic triazine polymer comprises a quinone structure, and
covalently grafting the polyamine to the organic triazine polymer is conducted by nucleophilic addition of the polyamine to the quinone group.

24. The method according to claim 16, wherein the acid catalyst is selected from Brønsted acids, Lewis acids or a combination thereof.

25. The method according to claim 16, further comprising dissolving or dispersing the intimate mixture in an inert solvent prior to being placed in a dry, oxygen-free polymerization device.

26. The method according to claim 16, wherein the intimate mixture comprises a heterocyclic aromatic compound having two or more carbonitrile groups, and the method further comprises treating the isolated microporous organic triazine polymer network having covalently bonded polyamine groups with a solution of a metal or a metal salt to coordinate the metal or metal ion of the salt with heteroatoms of the organic triazine polymer.

27. A method for removal of carbon dioxide from a gaseous mixture, comprising:
preparing an adsorbent bed containing the microporous organic triazine polymer network of claim 1, wherein the microporous organic triazine polymer network is essentially free of adsorbed CO₂;
exposing a gaseous mixture containing carbon dioxide to the adsorbent bed to i) physisorb the CO₂ into a microporous structure of the microporous organic triazine polymer network, ii) chemisorb the CO₂ by reaction with amine groups of the polyamine groups within the microporous structure of the microporous organic triazine polymer network; or iii) physisorb and chemisorb the CO₂ into a microporous structure of the microporous organic triazine polymer network according to i) and ii).

28. The method according to claim 27, wherein the gaseous mixture is atmospheric air, an off gas from a combustion process or an exhaust gas of fuel propelled vehicle.

29. The method according to claim 27, further comprising heating the adsorbent bed to a temperature of from 30° C. to 200° C., optionally under flow of an inert gas to expel the physisorbed and chemisorbed CO₂ and return the microporous organic triazine polymer network to being essentially free of adsorbed CO₂.

30. The method according to claim 29, wherein a time for heating the adsorbent bed is from 0.5 to 24 hours.

31. The method according to claim 29, wherein the exposing a gaseous mixture containing carbon dioxide to the adsorbent bed and heating the adsorbent bed having physisorbed and chemisorbed CO₂ to expel the physisorbed and chemisorbed CO₂ and return the microporous organic triazine polymer network to being essentially free of adsorbed CO₂ is cyclically repeated.

32. A method for removal of carbon dioxide from a gaseous mixture, comprising:
preparing an adsorbent bed containing the microporous organic triazine polymer network of claim 12, wherein the microporous organic triazine polymer network comprising a metal or metal ion coordinated and/or bonded with heteroatoms of the organic polymer network is essentially free of adsorbed CO₂;
exposing a gaseous mixture containing carbon dioxide to the adsorbent bed to i) physisorb the CO₂ into a microporous structure of the microporous organic triazine polymer network, ii) chemisorb the CO₂ by reaction with amine groups of the polyamine groups within the microporous structure of the microporous organic triazine polymer network; or iii) physisorb and chemisorb the CO₂ into a microporous structure of the microporous organic triazine polymer network according to i) and ii).

33. The method according to claim 32, wherein the gaseous mixture is atmospheric air, an off gas from a combustion process or an exhaust gas of fuel propelled vehicle.

34. The method according to claim 32, further comprising heating the adsorbent bed to a temperature of from 30° C. to 200° C., optionally under flow of an inert gas to expel the physisorbed and chemisorbed CO₂ and return the microporous organic triazine polymer network to being essentially free of adsorbed CO₂.

35. The method according to claim 34, wherein a time for heating the adsorbent bed is from 0.5 to 24 hours.

36. The method according to claim 34, wherein the exposing a gaseous mixture containing carbon dioxide to the adsorbent bed and heating the adsorbent bed having physisorbed and chemisorbed CO₂ to expel the physisorbed and chemisorbed CO₂ and return the microporous organic triazine polymer network to being essentially free of adsorbed CO₂ is cyclically repeated.

37. A device for removal of carbon dioxide from a gaseous mixture, comprising an adsorbent bed containing the microporous organic triazine polymer network of claim 1.

38. A device for removal of carbon dioxide from a gaseous mixture, comprising an adsorbent bed containing the microporous organic triazine polymer network comprising a metal or metal ion coordinated and/or bonded with heteroatoms of the organic polymer network of claim 12.
